(19) United States
(12) Patent Application Publication
(10) Pub. No.: US 2025/0251243 A1
(43) Pub. Date: Aug. 7, 2025

(54) Navigation System for the Visually Impaired

(71) Applicant: Hearsee, St. George, UT (US)

(72) Inventors: James Bloomfield, Bloomington, UT (US); Tyler Luce, Grand Rapids, MI (US); Joshua Eldridge, Grand Rapids, MI (US); Isaac Grotenhuis, Grand Rapids, MI (US); Scott Schmitz, Grand Rapids, MI (US)

(21) Appl. No.: 19/014,128

(22) Filed: Jan. 8, 2025

Related U.S. Application Data
(63) Continuation-in-part of application No. 17/843,841, filed on Jun. 17, 2022.
(60) Provisional application No. 63/618,897, filed on Jan. 8, 2024.
(60) Provisional application No. 63/212,009, filed on Jun. 17, 2021.

(51) Int. Cl. G01C 21/20; A61H 3/06; G06F 3/04845; G09B 21/00

(52) U.S. Cl. CPC G01C 21/206; A61H 3/061; G06F 3/04845; G09B 21/006; A61H 2201/5007

(57) ABSTRACT

A method may include presenting, by a software application, an image depicting a floor plan of a building. Using a user interface of the software application, a user may position multiple elements on the image and define each of the elements as a waypoint or destination. The user may position another element on the image and define it as a radio tag having an identifier. The user may further establish links between the various elements. The software application may generate navigation data based on what the user creates. Generating the navigation data may include defining certain links between selected elements as human-navigable paths. It may also include defining another link between elements as a location indicator establishing that receipt of the identifier from a user in a real-world environment indicates that the user is at a real-world location corresponding to the element defined as a radio tag.

### RELATED APPLICATION

This application: (1) is a continuation-in-part of U.S. patent application Ser. No. 17/843,841 filed Jun. 17, 2022, which claims the benefit of U.S. Provisional Patent Application Ser. No. 63/212,009 filed Jun. 17, 2021; and (2) claims the benefit of U.S. Provisional Patent Application Ser. No. 63/618,897 filed Jan. 8, 2024. Each of the foregoing applications is hereby incorporated by reference.

### TECHNICAL FIELD

This disclosure relates to navigation and, more particularly, to novel systems and methods for delivering information to and facilitating indoor and/or outdoor navigation for the visually impaired.

### BACKGROUND

Individuals who are visually impaired, and many others, have difficulty navigating in unknown or complex environments. Commonly, they must rely on traditional brail signs, marks in the walkways, and other mechanisms to navigate in a world designed for the sighted. These static mechanisms can make navigation in known or unknown environments difficult as they cannot provide constant and real-time information to act upon. Additionally, the user must find these mechanisms, which can pose a further hurdle for the visually impaired.

### SUMMARY

Disclosed herein are implementations of method for navigating. The method may include sending, to a server (e.g., a remote server), information identifying a first location within a building. In response to such sending, data comprising a plurality of unique identifiers may be received from the server. Each unique identifier of the plurality of unique identifiers may correspond to a unique radio tag located in a unique location within the building. Accordingly, the data may be used to deliver to a user a first series of audible commands guiding the user within the building toward the first location.

For example, as a user approaches or enters the building, a first radio transmission may be received from a first radio tag located within or proximate a building (e.g., proximate an entrance to a building). The first radio tag may be a passive RFID tag, an active RFID tag, a radio beacon, or the like. The first radio transmission may communicate or encode a first identifier (e.g., a first serial number, first latitude and longitude information identifying a location of the first radio tag, or the like) that uniquely corresponds to or identifies the first radio tag. The first identifier may be associated within the data to first navigation information. Accordingly, the first navigation information may be used to guide the user within the building toward the first location.

In selected implementations, the method may further include receiving a second radio transmission from a second radio tag located within the building. The second radio transmission may communicate or encode a second identifier (e.g., a second serial number, second latitude and longitude information identifying a location of the second radio tag, or the like) that uniquely corresponds to or identifies the second radio tag. The second identifier may be associated within the data to second navigation information. Accordingly, the second navigation information may be used to guide the user within the building toward the first location.

For example, the data may indicate that a location of the second radio tag is adjacent in a first direction to a location of the first radio tag. Accordingly, if the second radio transmission is received soon (e.g., immediately) after the first radio transmission, it may be indicative of the direction being traveled by the user, which may be factored in when guiding the user within the building to the first location.

At some point, a third radio transmission may be received from a third radio tag located within the building. The third radio transmission may communicate or encode a third identifier (e.g., a third serial number, third latitude and longitude information identifying a location of the third radio tag, or the like) that uniquely corresponds to or identifies the third radio tag. The third identifier may be associated within the data to third navigation information. Accordingly, the third navigation information may be used to guide the user within the building toward the first location. Thus, as a user progresses on a path through the building, one or more devices carried thereby may encounter various radio tags and use the information derived therefrom to assist in guiding the user within the building to the first location.

At some point in time, information identifying a second location within the building may be received from the user. Accordingly, the data may be used to issue a second series of audible commands that guide the user toward the second location. For example, the user may change his or her mind as to where he or she would like to go within the building and change an intended or desired destination from the first location to the second location. Alternatively, once the user has arrived at the first location and completed whatever tasks may be associated with that location, he or she may desire to move on to a second location (e.g., be guided to an exit door of the building).

In certain implementations, a system may be or comprise a server supporting navigation of one or more users through one or more buildings. Such a system may comprise at least one processor and memory operably connected to the at least one processor. The memory may store data. The data may comprise a plurality of unique identifiers. Each unique identifier may correspond to a unique radio tag located in a unique location within a building. The data may further comprise one or more attributes for each unique identifier. The one or more attributes may characterize the unique location within the building at which the unique radio tag corresponding to each unique identifier is located.

For example, the plurality of unique identifiers may comprise a first unique identifier, a second unique identifier, and a third unique identifier. The first unique identifier may correspond to a first unique radio tag located in a first unique location within the building. The second unique identifier may correspond to a second unique radio tag located in a second unique location within the building. The third unique identifier may correspond to a third unique radio tag located in a third unique location within the building. Accordingly, the one or more attributes for the first unique identifier may characterize the first unique location, the one or more attributes for the second unique identifier may characterize the second unique location, and the one or more attributes for the third unique identifier may characterize the third unique location.

In certain implementations, the one or more attributes for the first unique identifier may characterize the first unique location as being adjacent an entrance to a restroom contained within the building, an entrance to an elevator contained within the building, or an entrance to an office contained within the building. Other suitable attributes may include information identifying which other unique locations are adjacent and in which directions, other adjacent locations that may serve as desired destinations for certain users, or the like. Thus, the collection of attributes stored within the data may support navigation along various paths to various destinations within the building.

In selected implementations, the memory may further store instructions that cause the at least one processor to serve the data in response to a query comprising at least one unique identifier of the plurality of unique identifiers. Thus, once a software application corresponding to a user encounters a first radio transmission corresponding to a building or a portion of a building, that software may send a unique identifier corresponding to that transmission to the system and the system may return all the data required to navigate through the building or the portion of the building.

In certain implementations, a method may enable or equip a building to support navigation in accordance with the present invention. Such a method may comprise virtually dividing at least a portion of a floor of a building into a plurality of sections and mapping the plurality of sections to a plurality of radio tags. The mapping may assign one radio tag of the plurality of radio tags to one section of the plurality of sections. Thus, each section may have one radio tag assigned thereto and each radio tag may be assigned to one section. The plurality of radio tags may be installed within the building according to the mapping.

The method may further comprise programming the plurality of radio tags such that each radio tag thereof has a unique identifier (e.g., a unique serial number). Additionally, In certain implementations, the method may include programming a computer system with a mapping of the unique identifier of each radio tag to one or more attributes of a section corresponding to that radio tag.

For example, the plurality of radio tags may comprise a first radio tag, a second radio tag, and a third radio tag. The first radio tag may be installed within a first section of the plurality of sections, the second radio tag may be installed within a second section of the plurality of sections, and the third radio tag may be installed within a third section of the plurality of sections. Thus, the one or more attributes corresponding to the first section may be mapped in the programming to a unique identifier of the first radio tag, the one or more attributes corresponding to the second section may be mapped in the programming to a unique identifier of the second radio tag, and the one or more attributes corresponding to the third section may be mapped in the programming to a unique identifier of the third radio tag.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an example of a navigation system for the visually impaired according to various embodiments described herein.

FIG. 2 is an enlarged perspective view of an example of a reading device according to various embodiments described herein.

FIG. 3 is an enlarged perspective view of another example of a reading device according to various embodiments described herein.

FIG. 4 is an enlarged perspective view of an example of a client device according to various embodiments described herein.

FIG. 5 is a cross-sectional elevation view of an example of a radio tag coupled to an object and a surface according to various embodiments described herein.

FIG. 6 is a block diagram of an example of a reading device according to various embodiments described herein.

FIG. 7 is a block diagram of an example of a client device according to various embodiments described herein.

FIG. 8 is a block diagram of an example of a processing unit according to various embodiments described herein.

FIG. 9 is a side view of a reading device configured as a cane or walking stick.

FIG. 10 is a side view of one embodiment of a handle of a cane or walking stick in accordance with the present invention.

FIG. 11 is a schematic diagram of one embodiment of the electronics of a reading device in accordance with the present invention.

FIG. 12 is a schematic diagram of an alternative embodiment of a system in accordance with the present invention wherein the reading device is incorporated within a cane or walking stick, the client device is incorporated within or comprises a software application running on a smart phone or other mobile device, and the client device is in communication with a server (e.g., a remote server).

FIG. 13 is a schematic diagram of one embodiment of speech to text functionality that may be supported or provided by a client device in accordance with the present invention.

FIG. 14 is a flow chart of one embodiment of a method for building out a space with radio tags in accordance with the present invention.

FIG. 15 is a sample floor plan of an office building that may be built out with the radio tags in accordance with the present invention.

FIG. 16 is a flow chart of a method for using a system in accordance with the present invention.

FIG. 17 is a workflow diagram of RFID sensing functionality that may be supported or provided by a system in accordance with the present invention.

FIG. 18 is a screen shot of a home screen of one embodiment of a software application forming a client device or providing certain functionality of a client device in accordance with the present invention.

FIG. 19 is a screen shot of a home screen of the software application of FIG. 18 as a voice command is being received by the software application.

FIG. 20 is a screen shot of the software application of FIG. 18 as the software application searches for information or data that may be responsive or relevant to a voice command received by the software application.

FIG. 21 is a screen shot of the software application of FIG. 18 as the software application presents a listing of results (e.g., potential destinations) that may be responsive or relevant to a voice command received by the software application.

FIG. 22 is a screen shot of the software application of FIG. 18 as the software application presents a navigation instruction set that will direct a user to a particular destination.

FIG. 23 is a workflow diagram of cane-finding functionality that may be supported or provided by a system in accordance with the present invention.

FIG. 24 is a screen shot of a user interface of a build-out application identifying an organization and the buildings and team members pertaining to the organization.

FIG. 25 is a screen shot of a user interface of a build-out application showing a building and the floors pertaining to the building.

FIG. 26 is a screen shot of a user interface of a build-out application where a user is being prompted to upload an image of a floor plan of a building.

FIG. 27 is a screen shot of a user interface of a build-out application where a user is being prompted to enter an angle of a floor plan with respect to the geographic North Pole of the earth.

FIG. 28 is a screen shot of a user interface of a build-out application where a user is being prompted to enter a physical distance of a line drawn on a floor plan in order to establish a scale of the floor plan.

FIG. 29 is a screen shot of a user interface of a build-out application where a user is adding an element (e.g., an element representing a destination) to a floor plan.

FIG. 30 is a screen shot of a user interface of a build-out application where a user is adding another element (e.g., another element representing a destination) to the floor plan of FIG. 29.

FIG. 31 is a screen shot of a user interface of a build-out application where a user has added various elements (e.g., elements representing destinations, waypoints, and beacons) to a floor plan and has not yet added any elements representing radio tags.

FIG. 32 is a schematic diagram showing multiple floor plans linked together by an element representing a portal (e.g., an elevator, stairwell, or the like).

FIG. 33 is a schematic diagram showing multiple buildings linked together by a linking structure (e.g., a side walk, skyway, breeze way, or the like).

FIG. 34 is a top perspective view of a reading device in a compact form factor.

FIG. 35 is a bottom perspective view of the reading device of FIG. 34.

FIG. 36 is an exploded view of the reading device of FIG. 34.

FIG. 37 is a top plan view of the reading device of FIG. 34.

FIG. 38 is a bottom plan view of the reading device of FIG. 34.

FIG. 39 is a front view of the reading device of FIG. 34, which view is identical to the back view and at least one side view of the same device.

FIG. 40 is a side view of the reading device of FIG. 34 showing the port formed therein.

### DETAILED DESCRIPTION

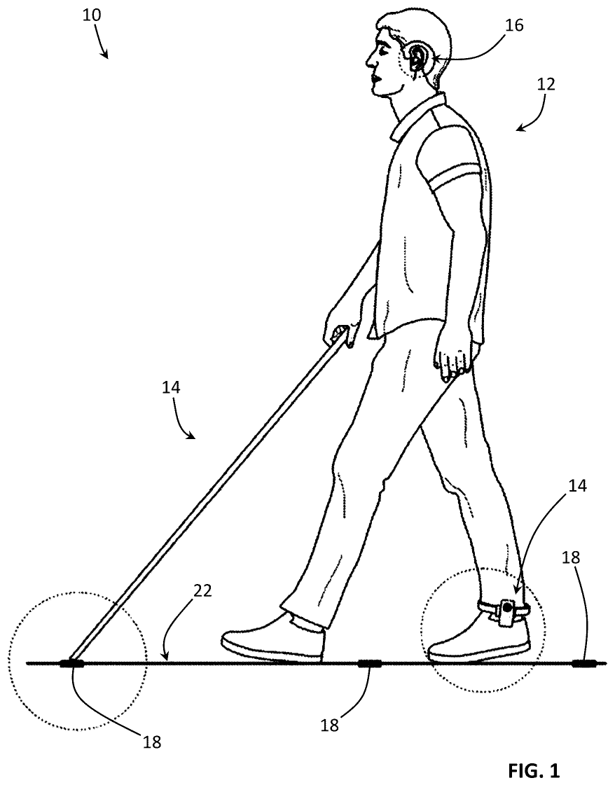

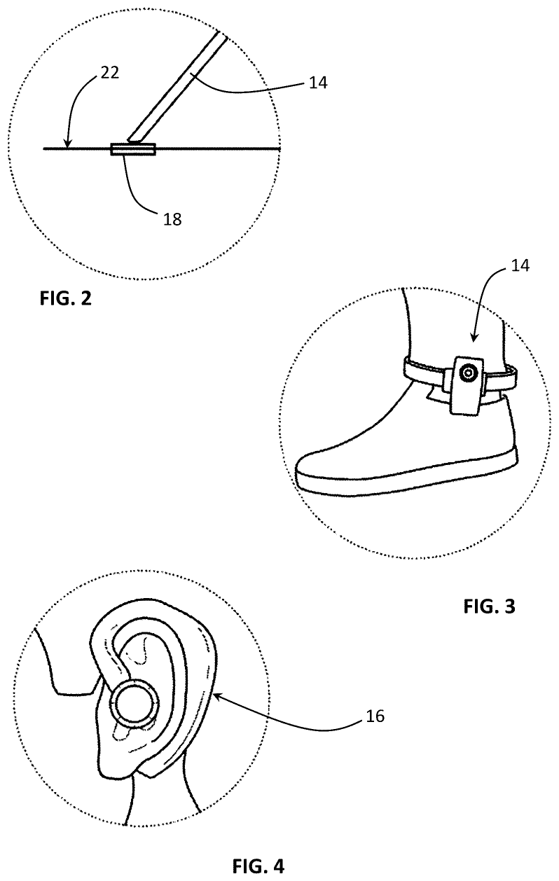

Referring to FIGS. 1-4, a system 10 for a user 12 that is visually impaired and/or other individuals may comprise a reading device 14, client device 16, and one or more radio tags 18. A reading device 14 may be an assistive device, wearable, or the like that is carried, manipulated, and/or worn by a user 12. A client device 16 may be, comprise, or form part of a smart phone, an earpiece, a smart phone and earpiece or headphone combination, a wrist device, or the like.

In selected implementations, an earpiece, headphone, or the like forming or associated with a client device 16 may include a pass-through feature or ambient-sound mode that helps a user to hear what is known as “ambient noise,” even while wearing the earpiece, headphone, or the like. In an ambient sound mode, an earpiece, headphone, or the like may enable a user to control a volume of ambient sound independent of other sounds played by the earpiece, headphone, or the like (e.g., independent of tones, voice-based instructions or information, or the like passed from a client device 16 to an earpiece, headphone, or the like). In certain implementations, an earpiece, headphone, or the like may include a pressure relief valve (e.g., a one-way or two-way pressure relief valve) that may release or resolve any pressure differential that may exist between an inner space (i.e., a space between an output of an earpiece or the like and an ear drum of a user) and an outer or ambient space.

In certain implementations, each reading device 14 may be in communication with a client device 16 that corresponds thereto. One or more radio tags 18 may be disposed in an environment by being connected to a plurality of objects 20 and/or surfaces 22. A reading device 14 may be manipulated by a user 12 so that the reading device 14 may be placed in proximity to a radio tag 18. Accordingly, a radio tag 18 may wirelessly pass data to a reading device 14 and a reading device 14 may wirelessly pass data to a client device 16.

The data passed from a radio tag 18 to a reading device 14 may include information describing the environment proximate to the radio tag 18, such as location data, addresses, building names, navigation way-points inside buildings, etc. The client device 16 may output the data to the user 12 in audible, visual, and/or tactile format. Alternatively, the data may simply comprise a serial number or the like. Accordingly, after a reading device 14 passes the serial number to a client device 16, the client device 16 may use the serial number to download, look up, or otherwise obtain information that has been linked to that serial number. This information or some portion or derivative thereof may be output to the user 12 in audible, visual, and/or tactile format or may be used by the client device 16 to provide some other benefit to the user 12 (e.g., support computerized navigation of the user 12 to a particular destination, provide contextual information to the user 12 such as location data, addresses, direction of travel, building names, points of interest and cultural significance, or any other information that may be useful for keeping the user 12 constantly or regularly appraised of his or her exact location, direction of travel, surroundings, etc.).

In selected implementations, a system 10 may comprise a plurality of radio tags 18 coupled or secured to objects and/or surfaces such as buildings, fences, sign posts, light posts, traffic signals, roads and their surfaces, sidewalks, and the like. Alternatively, or in addition thereto, one or more radio tags 18 may be disposed on, along, and/or proximate certain walkways (e.g., areas that a user 12 may walk along or through to get to a destination) so that the information they contain may be read by a reading device 14 and benefit a user 12 moving or navigating along those walkways. In certain implementations, the radio tags 18 may be disposed on or coupled to steps, hallways, staircases, doors, barriers, walls, ceilings, base boards, flooring, or any other object associated with walkways.

In certain implementations, radio tags 18 may comprise radio-frequency identification (RFID) tags that contain electronically stored information. Encoded electromagnetic transmissions may be used to pass data from one or more radio tags 18 to a reading device 14. In selected implementations or locations, one or more radio tags 18 may be or comprise passive RFID tags that collect and use energy from a nearby RFID reader's interrogating radio waves to produce a reply (e.g., a response comprising an electromagnetic transmission). In other implementations or locations, one or more radio tags 18 may be or comprise active RFID tags that have a power source (e.g., a battery and/or wired power connection) and may communicate with (e.g., pass information to) an RFID reader located farther away therefrom. In still other implementations or locations, one or more radio tags 18 may comprise Bluetooth Low Energy (BLE) beacons.

In certain implementations, a system 10 may comprise one or more radio tags 18 that may be in wired communication, such as via wires, leads, conductive strips, low voltage wire, or other wired connection, with one or more power sources. The one or more power sources may provide power to the radio tags 18. Alternatively, or in addition thereto, wires or the like may enable one or more radio tags 18 to communicate with one or more computing devices (e.g., an RFID programming unit) that may be used to modify the data that the radio tags 18 emit in response to a reading device 14. In selected implementations, radio tags 18 may comprise any type of device that may wirelessly communicate information to a reading device 14 of a user 12 as the user 12 moves or navigates through an environment.

A reading device 14 may be or be located within a cane, walking stick, walker, some other assistive device, bracelet, shoe, ankle bracelet, some other wearable device, or the like. Accordingly, as a user 12 navigates or moves through an environment, a reading device 14 carried by the user 12, carried by a guide animal corresponding to the user 12 (e.g., included within a collar, leash, or harness of a guide animal), or the like may pass within range of one or more radio tags 18 (e.g., one or more RFID tags, RFID beacons, BLE beacons, or the like or combinations or sub-combinations thereof) positioned within that environment. For example, a reading device 14 located (or having an antenna located) proximate a tip of a cane or walking stick, in an ankle bracelet, or in some other appropriate location on or within an assistive device or wearable may pass in close proximity to one or more radio tags 18 secured to a floor, base board, or lower wall surface. This may facilitate reliable communication between the radio tags 18 and the reading device 14, particularly when the radio tags 18 are configured as passive RFID tags.

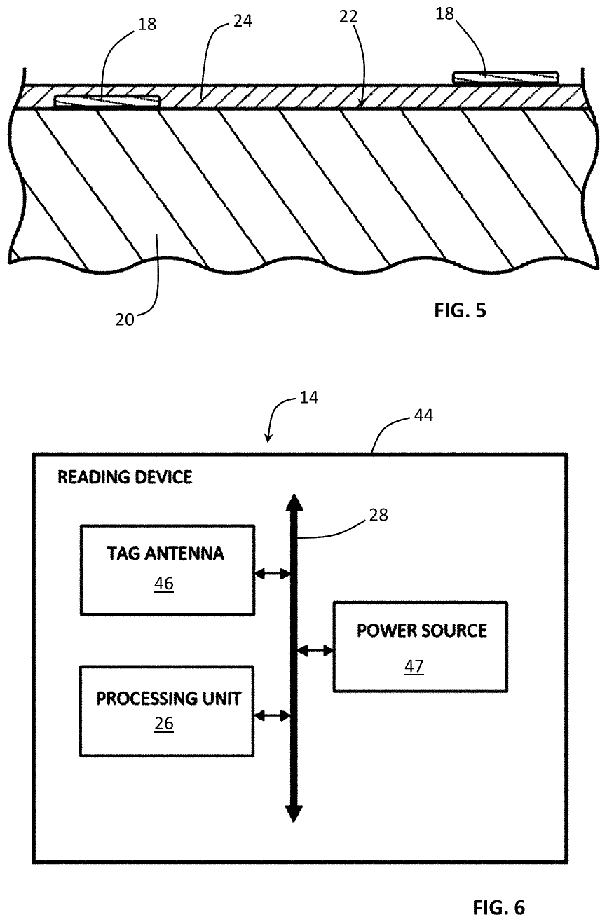

Referring to FIG. 5, one or more radio tags 18 may be affixed, embedded, or otherwise coupled to one or more objects 20 and surfaces 22. In certain implementations, a radio tag 18 may be coupled to an object 20 or surface 22 via a fixative 24. A fixative 24 may comprise an adhesive, glue, heat bonding element, fastener (e.g., a nail, screw, bolt, rivet, staple, etc.), or the like. Alternatively, one or more radio tags 18 may be imbedded in one or more objects 20 or surfaces 22 during construction and/or be painted on to objects 20 and surfaces 22 (e.g., installed and then painted over) during or after construction. Accordingly, radio tags 18 may be incorporated within an environment (e.g., a building) as part of an original construction effort or in a retrofit or upgrading process.

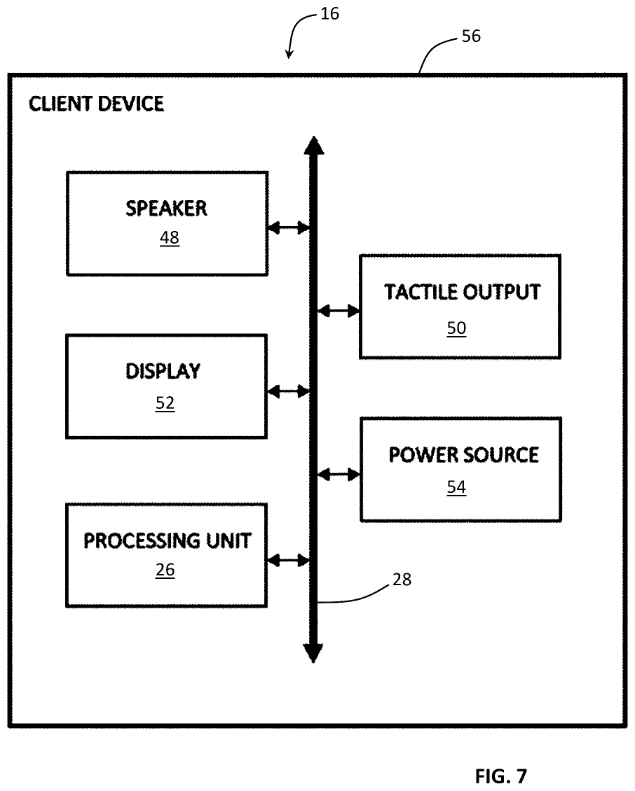

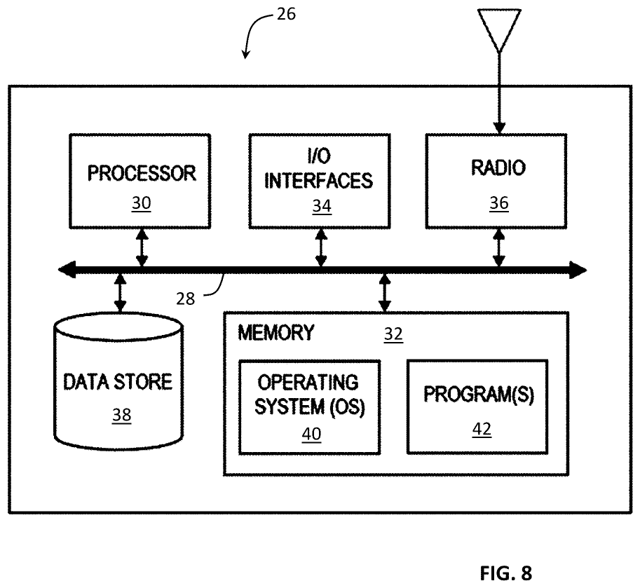

Referring to FIGS. 6-8, in certain implementations, a reading device 14 and/or client device 16 of a system 10 in accordance with the present invention may comprise or be configured as digital devices comprising one or more processing units 26. FIG. 8 depicts an example of a processing unit 26 that is relatively simple. In other implementations, a processing unit 26 may include additional components or elements.

The components of a reading device 14 and a client device 16 may be communicatively coupled via a local interface 28, The local interface 28 can be, for example but not limited to, one or more buses or other wired or wireless connections, integrated circuits, etc. The local interface 28 may have additional elements such as controllers, buffers (caches), drivers, repeaters, receivers, or the like or a combination or sub-combination thereof to support a desired functionality. Further, a local interface 28 may include addressing, control, and/or data connections to enable appropriate communications among various components connected thereto.

A processor 30 may be a hardware device for executing software instructions. Accordingly, when a processing unit 26 is in operation, a processor 30 may execute software stored within memory 32, communicate data to and from memory 32, and/or otherwise control operations of a reading device 14 or client device 16 pursuant to the software instructions. In an exemplary embodiment, the processor 30 may be or comprise a mobile optimized processor that is optimized for lower power consumption requirements or goals typically associated with mobile applications.

In selected implementations, one or more I/O interfaces 34 may be used to input and/or output information and/or power. In some embodiments, I/O interfaces 34 may include one or more turnable control knobs, depressible button-type switches, key pads, slide-type switches, dip switches, rocker-type switches, rotary dial switches, numeric input switches, or any other suitable input through which a user 12 may interact with a processing unit 26 or reading device 14 or client device 16. In certain implementations, one or more I/O interfaces 34 may include one or more light emitting elements or other display devices (e.g., one or more light emitting diodes), one or more speakers, and/or any other suitable device for outputting or displaying information. One or more I/O interfaces 34 may also include a serial port, a parallel port, a small Computer System interface (SCSI), an infrared (IR) interface, a radio frequency (RF) interface, a universal serial bus (USB) interface, and/or the like.

A radio 36 may enable wireless communication to an external access device or network. In selected implementations, a radio 36 may operate via Bluetooth and/or WiFi communication standards. Alternatively, or in addition thereto, a radio 36 may operate on a cellular band and may communicate with or receive a Subscriber Identity Module (SIM) card or other wireless network identifier. Any number of suitable wireless data communication protocols, techniques, or methodologies may be supported by a radio 36, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g., 3G, 4G, 5G, or the like); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and/or any other protocols for wireless communication.

A data store 38 may be used to store data. A data store 38 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, a data store 38 may incorporate electronic, magnetic, optical, and/or other types of storage media.

Memory 32 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, memory 32 may incorporate electronic, magnetic, optical, and/or other types of storage media. Memory 32 may have a distributed architecture, wherein various components are situated remotely from one another, but can be accessed by the processor 30. Software stored in memory 32 may include one or more software programs, each of which may include an ordered listing of executable instructions for implementing logical functions.

In certain implementations, software stored in memory 32 may include an operating system 40 or “OS” and one or more programs 42 or applications. An operating system 40 may be LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (available from Research in Motion), Raspbian (available from the Raspberry Pi Foundation), or the like. One or more programs 42 may include various applications, add-ons, or the like that are configured to provide certain functionality for the reading device 14 or client device 16. For example, one or more programs 42 may include, but are not limited to, environmental variable analytics and modulation of I/O interface 34 functions. In certain implementations, a user 12 may use one or more of the programs 42 to control one or more functions of a reading device 14 or a client device 16.

In selected implementations, a reading device 14 may be a digital device that, in terms of hardware architecture, may optionally comprise one or more processing units 26, a tag antenna 46, and a power source 47. In other implementations, a reading device 14 may include additional components or elements and suitably configured processing logic to support desired functionality.

One or more components of a reading device 14 may be contained in or coupled together via a reading device housing 44. A reading device housing 44 may be configured in any size and shape. In certain implementations, a reading device housing 44 may be configured as a white cane such as may be used by those who are blind or visually impaired. In other implementations, a reading device housing 44 may be configured as any other type of assistive device such as a walking stick, walking cane, hiking stick, walker, or the like or a wearable that may be used by a user 12 when moving through an environment. In selected implementations, a reading device housing 44 may be configured as an ankle bracelet that may be worn around an ankle of a user 12. In other implementations, a reading device housing 44 may be configured as an article of footwear, such as a shoe that may be worn on a foot of the user 12. In still other implementations, a reading device housing 44 may be coupled to or removably coupled to objects such as a white cane so that the object may be retrofit to become a reading device 14 within a system 10 in accordance with the present invention. In certain implementations, a reading device housing 44 may be collapsible or foldable to facilitate storage of the reading device 14.

A tag antenna 46 may be configured to read the data of a radio tag 18 located proximate thereto. In selected implementations, a tag antenna 46 may be configured as part of a Passive Reader Active Tag (PRAT) system that receives radio signals from radio tags 18 that are active. In other implementations, a tag antenna 46 may be configured as part of an Active Reader Passive Tag (ARPT) system that transmits interrogator signals and receives authentication replies from radio tags 18 that are passive. In still other implementations, a tag antenna 46 may be configured as part of an Active Reader Active Tag (ARAT) system wherein radio tags 18 that are active are awoken with an interrogator signal from an active reader. In still other implementations, a tag antenna 46 may be configured to work with radio tags 18 that are Battery-Assisted Passive (BAP) tags that act like passive tags, but have small batteries to power a return reporting signal output by the tag to increase the range of that signal. Accordingly, a tag antenna 46 may comprise any device or system that facilitates or enables wirelessly receiving data from a radio tag 18.

A reading device 14 may comprise a power source 47 that may provide electrical power to any component thereof that requires electrical power. A power source 47 may comprise a battery, a fuel cell, a capacitor, a super capacitor, or any other type of energy storing and/or electricity releasing device. In certain implementations, a power source 47 may comprise a power cord, kinetic or piezoelectric battery charging device, a solar cell or photovoltaic cell, and/or inductive charging or wireless power receiver. In other implementations, a power source 47 may include a power charging and distribution module that may be configured to control a charging, recharging, and/or discharging process and/or the distribution of power to one or more components of a reading device 14.

A client device 16 may be a digital device that, in terms of hardware architecture, may optionally comprise one or more processing units 26, a speaker 48, a tactile output 50, a display 52, a power source 54, or the like or a combination or sub-combination thereof. In other implementations, a client device 16 may include one or more additional components or elements to support desired functionality.

One or more components of a client device 16 may be contained in or coupled together via a client device housing 56. A client device housing 56 may be configured in any size and shape. In preferred embodiments, a client device 16 and a client device housing 56 corresponding thereto may be configured as a smart phone, tablet computer, or other handheld computing device. In certain implementations, a client device 16 and a client device housing 56 corresponding thereto may be configured as an ear piece or headset which may be worn by a user 12 when moving through an environment. In still other implementations, a client device 16 and a client device housing 56 corresponding thereto may be configured to be worn on other parts of the body of a user 12, such as on the ankle, waist, wrist, shoulder, and/or any other body location that may allow the client device 16 to be worn by a user 12 when moving through an environment.

A client device 16 may comprise or be connected to a speaker 48 (e.g., wired or wireless headphones) configured to output audible information to a user 12. In selected implementations, a speaker 48 may be configured to produce sounds (e.g., one or more voices, tones, or the like) that may be used to audibly communicate selected information to a user 12.

In selected implementations, a client device 16 may comprise a tactile output 50, audible output (e.g., a piezoelectric buzzer), or the like or a combination thereof that may be configured to output tactile and/or audible information to a user 12. Preferably, a tactile output 50 may be configured to produce vibrations and/or pulses that may be used to communicate selected information to a user 12. A tactile output 50 may comprise a long life brushless (BLDC) vibration motor, a coin or pancake vibration motor, an encapsulated vibration motor, an enclosed vibration motor, a pager motor, an eccentric rotating mass (ERM) motor, a linear resonant actuator (LRA), a printed circuit board (PCB) mounted vibration motor, or any other electrical device capable of producing a series of rapid and/or repeated movements. In selected implementations, a tactile output 50, audible output (e.g., a piezoelectric buzzer), and/or the like may be included as part of a reading device 14 (e.g., a reading device 14 configured as a cane or walking stick). Accordingly, a reading device 14 may produce vibrations, pulses, sounds, or the like or a combination thereof that may be used to communicate selected information to a user 12.

A client device 16 may comprise a display 52 which may be configured to output visual information to a user 12. In selected implementations, a display 52 may be configured to provide visual information to a user 12 and, optionally, to receive input from a user 12 (e.g., a display 52 may comprise or be a touch screen display).

A client device 16 may comprise a power source 54 that may provide electrical power to one or more components of the client device 16. A power source 54 may comprise a battery, a fuel cell, a capacitor, a super capacitor, or any other type of energy storing and/or electricity releasing device. In other implementations, a power source 54 may comprise a power cord, kinetic or piezoelectric battery charging device, a solar cell or photovoltaic cell, and/or inductive charging or wireless power receiver. In certain implementations, a power source 54 may include a power charging and distribution module that may be configured to control a charging, recharging, and/or discharging process and/or the distribution of power to one or more components of a client device 16.

In selected implementations, a reading device 14 and a client device 16 may be integrally formed or otherwise coupled together so that the reading device 14 and client device 16 may be in communication via a wired local interface 28. In other implementations, a reading device 14 and a client device 16 may be separate from each other and may communicate wirelessly via the radios 36 that respectively form part thereof.

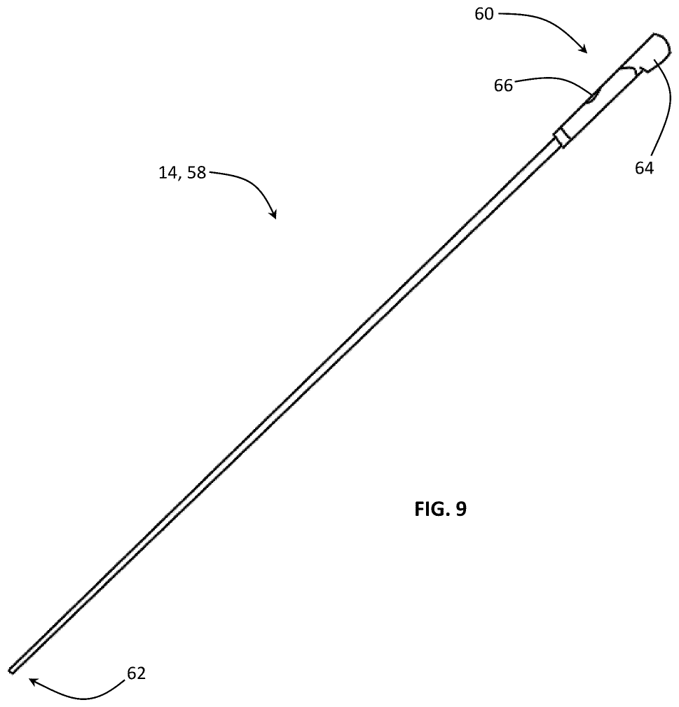

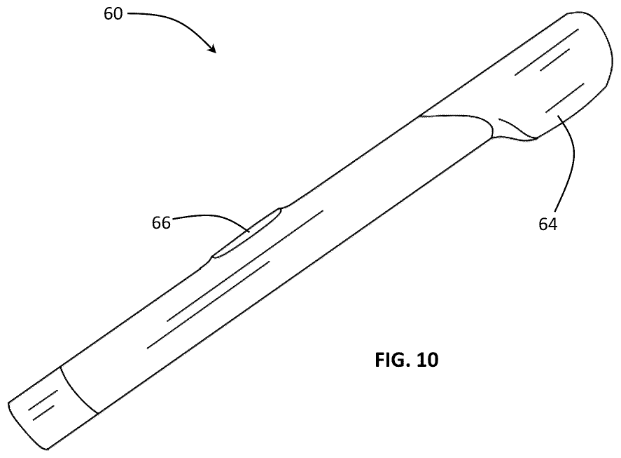

Referring to FIGS. 9 and 10, a reading device 14 may be configured as or form part of a cane 58 or walking stick. For example, a printed circuit board (and the various components thereof or associated therewith) may be position within a handle 60 of a cane 58. A power source 47, a tactile output 50, and the like may also be contained within the handle 60. A tag antenna 46 (e.g., an RFID reader antenna) or multiples thereof may be included or positioned within a tip 62 of a cane 58. Accordingly, wiring (e.g., coaxial cable) may extend from a tag antenna 46 in a tip 62 of the cane 58 to a printed circuit board in the handle 60 of the cane 58 (e.g., to a printed circuit board in a bulge or protrusion 64 formed in the handle 60 of the cane 58).

In selected implementations, a cane 58 may include a switch 66 or button that may be used to turn a reading device 14 “ON” and “OFF.” Such a switch 66 or button may be raised or otherwise shaped so as to be easily felt and identified by a user 12. A tactile output 50 and/or buzzer may be used to provide non-visual feedback that a reading device 14 has been properly turned ON or OFF. Various lights (e.g., red, green, and/or yellow LEDs) may also provide feedback as to a current state or condition of a reading device 14. In certain implementations, a reading device 14 may include a port (e.g., a USB-C port) that may enable charging of the power source 47.

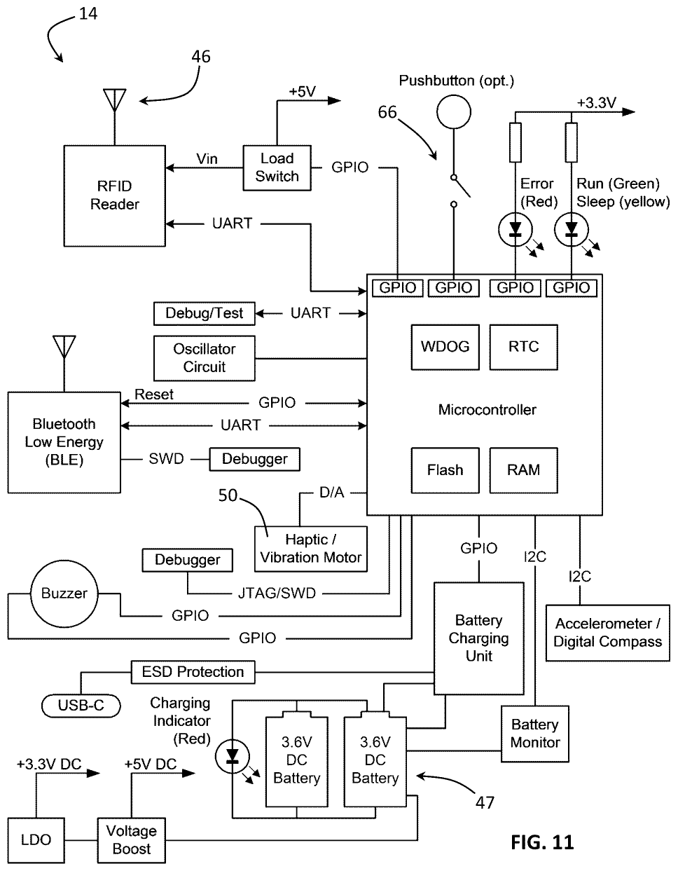

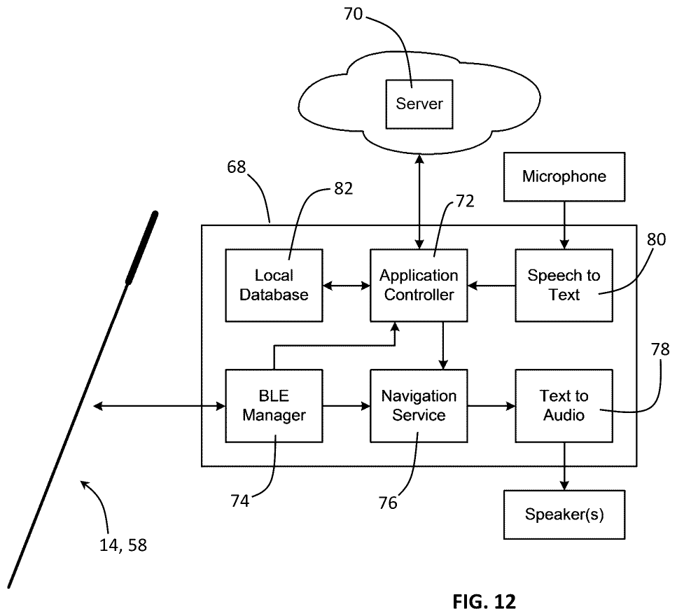

Referring to FIG. 11, in selected implementations, the electronics of a cane 58 or other reading device 14 (e.g., a reading device 14 configured as an assistive device or a wearable) may include a microprocessor. The microprocessor may be connected to various LED lights, a switch 66, an RFID reader with a tag antenna 46, an oscillator circuit, a BLE module with corresponding antenna, a haptic or vibration motor (i.e., a tactile output 50), a buzzer, a battery charging unit, a battery monitor, an accelerometer or digital compass, or the like or a combination or sub-combination thereof. The connections between the microprocessor and such components may have the format or be of the type as labeled. In certain implementations, the battery charging unit may be connected to the power source 47, a USB-C port, or the like or a combination thereof.

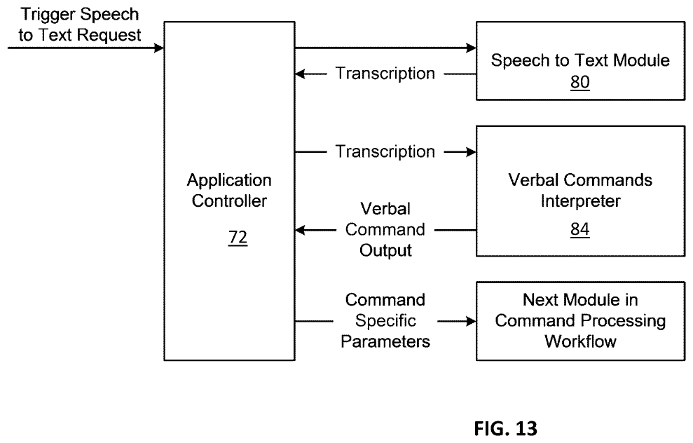

Referring to FIGS. 12 and 13, in selected implementations, a system 10 may comprise a reading device 14 configured as a cane 58 or walking stick, a client device 16 comprising or configured as a mobile application 68 running on a mobile device (e.g., on a smart phone) carried by a user 12, and a server 70 (e.g., a remote server). The mobile application 68 may include an application controller 72, BLE manager 74, navigation service module 76, text-to-audio module 78, speech-to-text module 80, database 82 (e.g., local database), and the like or a combination or sub-combination thereof.

During operation, a reading device 14 may wirelessly pass (e.g., via BLE) certain data (e.g., one or more serial numbers of one or more radio tags 18) to a mobile application 68 (e.g., to a BLE manager 74 of a mobile application 68). The mobile application 68 (e.g., an application controller 72 of the mobile application 68) may pass the one or more serial numbers to a server 70 and/or use the serial numbers as part of a request for data (e.g., a request for a database or one or more tables) from the server 70. In response, a server 70 may serve to the mobile application 68 certain data corresponding to the serial numbers. That data may thereafter be stored within a local data store or database 82 (e.g., a database stored within memory of a smart phone or other mobile device). Accordingly, the client device 16 may use that locally stored data to provide benefit to a user 12.

For example, as a user 12 enters a building or other space, a reading device 14 may substantially immediately collect a serial number from a radio tag 18 located proximate an entrance to the building or space. This serial number may be passed from the reading device 14 to a client device 16 (e.g., a mobile application 68 running on a smart phone or other mobile device) and from the client device 16 to a server 70 (e.g., a service connected to the Internet and accessed via a data connection of the smart phone or other mobile device). The server 70 may recognize the serial number as pertaining to a particular space and serve to the client device 16 a database or one or more tables corresponding to that space. Such a database or collection of tables may identify the various serial numbers of the one or more radio tags 18 located in the space and identify what attributes are linked to each of those serial numbers. Accordingly, upon entering the building or space, a client device 16 may be ready to assist the user 12 in navigating to any desired destination within that space.

In selected implementations, a client device 16 (e.g., a speech-to-text module 80 of a mobile application 68) may support speech to text conversions. The client device 16 (e.g., a text- to-audio module 78 module of a mobile application 68) may support text to speech conversions. In certain implementations, this may be done or facilitated by leveraging certain speech to text and/or text to speech functionality built into an operating system 40 of a smart phone or other mobile device that forms the hardware portion of (or enables the operation of) the client device 16.

In operation, a user may trigger a speech to text request. An application controller 72 may receive this request and pass the corresponding audio to the speech-to-text module 80. The speech-to-text module 80 may return a transcription of the audio to the application controller 72. The application controller 72 may send the transcription to a verbal commands interpreter 84, which may return to the application controller 72 verbal commands corresponding to the transcription. The application controller 72 may then command specific parameters and the next module in the command processing workflow may continue the process or work to implement or act on the specific parameters.

Accordingly, a user 12 may issue a command such as “navigate to men's room.” This command may be converted to text. The text may then be analyzed to determine the nature of the command. For example, by analyzing the text of the command to “navigate to men's room,” the client device 16 may determine that navigation services are desired and that the destination is a men's restroom. Accordingly, the client device 16 may identify within the data obtained from the server 70 where the nearest men's restroom is located and formulate instructions for conducting or guiding the user 12 from a current location to that men's restroom. These instructions may be converted to speech and passed to the user 12 via a speaker, headphone, or the like. Because the data for the space may be obtained from the server 70 early in the process and then stored locally, navigation of the user 12 to any of one or more destinations within the space may be provided even in situations where a data connection between a client device 16 and a server 70 is lost, weak, or otherwise problematic.

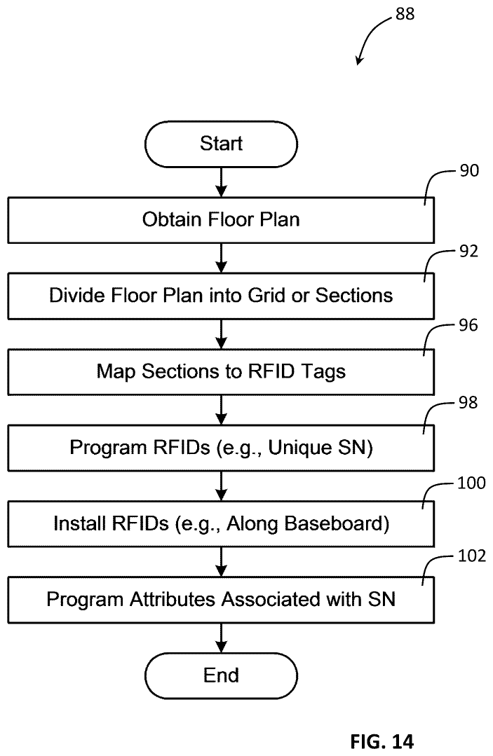

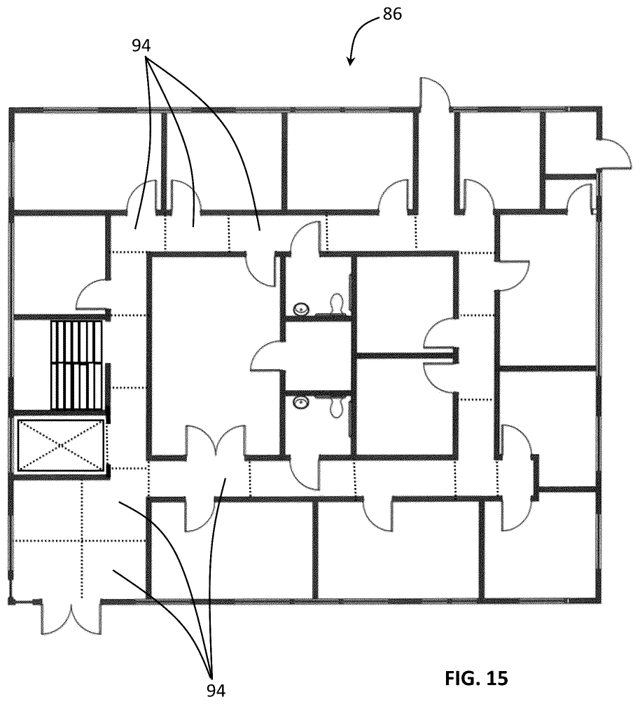

Referring to FIGS. 14 and 15, to support the operation of a system 10, one or more spaces 86 may be built out with a plurality of radio tags 18. A space 86 may be a location or environment where certain current forms of navigation (e.g., GPS navigation) may be compromised, unavailable, and/or insufficiently precise. For example, a space 86 may be an interior of a building such as an office building, court house, hospital, museum, conference center, hotel, airport terminal, stadium, subway station, shopping center, supermarket, parking garage, or the like. In other words, a space 86 may be a building that receives a significant number of visitors that are not completely knowledgeable regarding where everything is located within that building. Moreover, a space 86 may be a building wherein the owners and/or operators thereof may be motivated by good will, financial interest, and/or legal requirements to make the space more readily accessible to a user 12 that is visually impaired.

A method 88 of building out a space 86 may begin with obtaining 90 a floor plan of the space 86. Thereafter, the floor plan may be logically or virtually divided 92 into a grid or plurality of segments or sections 94. The granularity of a grid (e.g., the number of sections 94) may be selected to support a desired precision of navigation. In certain implementations, each section 94 may be located and/or sized such that a relatively few steps (e.g., 3 to 5 steps) may transition a user 12 from a section 94 to another section 94 adjacent thereto. For example, from the center of a section 94 to the center of another section 94 adjacent thereto may be about ten feet. This level of granularity may be economically feasible while still providing enough navigational touch points to avoid unnecessary or undesirable ambiguity or imprecision.

In the sample office-building floor plan shown in FIG. 15, the walking spaces that would need to be divided 92 into a grid are rather narrow. They consist of relatively narrow hallways (e.g., hallways that are about ten feet wide or less) that extend to connect elevators, stairs, restrooms, offices, etc. Accordingly, a grid for such a floor plan may be relatively simple and comprise a series of sections 94 that extend from one side of the hallway to the other and typically only boarder the sections 94 on two opposite ends thereof. As appreciated a more open floor plan such as what may be found in a museum may be divided 92 into a grid where one or more sections 94 thereof are completely surrounded by other sections 94 of the grid.

Once a floor plan has been logically or virtually divided 92 into a grid or plurality of sections 94, each of the sections 94 may be mapped 96 to a radio tag 18 (e.g., a unique RFID tag, RFID beacon, BLE beacon, or the like). This may include deciding which radio tags 18 may best fit which sections 94 (e.g., larger sections or segments may be better served by active RFID tags, RFID beacons, BLE beacons, or the like due to the greater distances that may be involved), deciding where within each section 94 should the radio tag 18 be placed, and/or the like. Thereafter, the radio tags 18 may be programmed 98 (e.g., programmed with a unique serial number) and installed 100 within the space 86.

As part of an installation process, records may be kept or created that identify which radio tags 18 (e.g., which serial numbers) correspond to which attributes of a space 86. For example, one or more radio tags 18 may be waypoints and nothing more. That is, they may correspond to areas that must be walked through to get to one or more destinations, but they may not be destinations themselves. Other radio tags 18 may be waypoints and destinations. In other words, they may correspond to a portion of a hallway that must be walked through to get to one or more destinations, but they may also be a destination themselves because they are immediately outside of a particular office. Accordingly, in some computerized record (e.g., a database, one or more tables, or the like), the serial numbers of the one or more radio tags 18 may be associated 102 with (e.g., programmed to correspond to) the attributes of that location within the space 86. Attributes may include being (1) a starting point (e.g., an entrance to a particular building, an entrance to a particular floor, etc.), (2) an ending point (e.g., a destination within or exit for a particular building), (3) a waypoint that is adjacent one or more other waypoints in certain directions, and/or (4) adjacent on a specified side to a men's restroom, women's restroom, elevator door, stairway, stairway door, drinking fountain, vending machine, kiosk, reception desk, office door, safety hazard, or any other feature that could be important to a user 12 moving within or navigating through the space 86. In certain implementations, one or more attributes corresponding to a radio tag 18, identifier of a radio tag 18, or the like may constitute navigation information for the radio tag 18 or identifier.

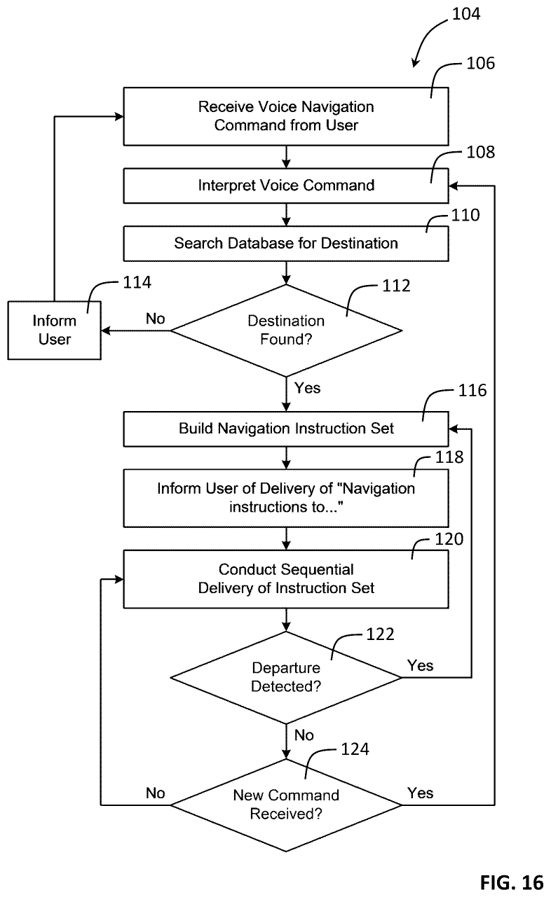

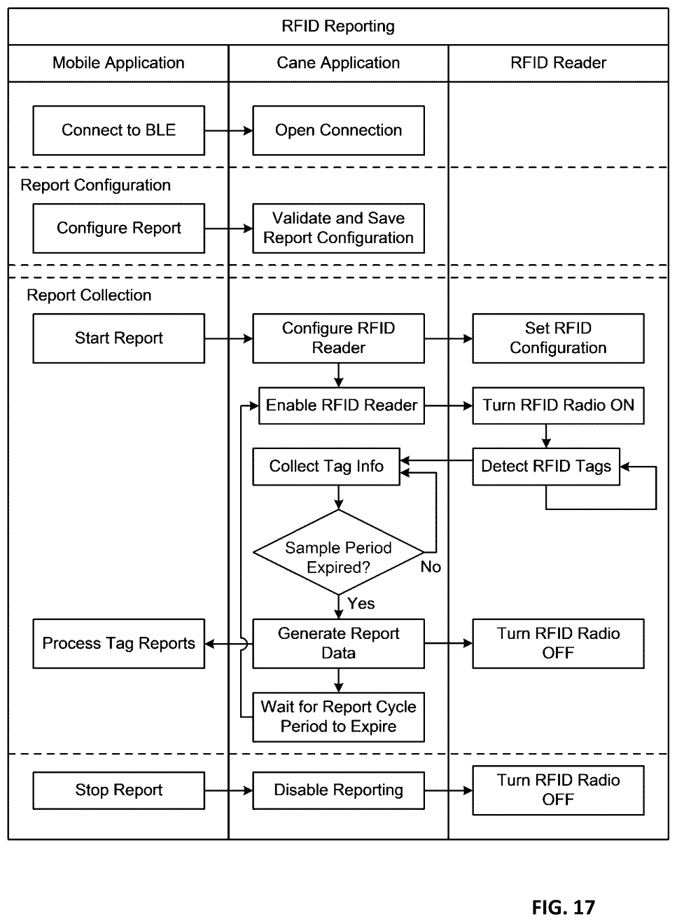

Referring to FIGS. 16 and 17, in selected implementations, a method 104 for using a system 10 in accordance with the present invention may begin when a client device 16 (e.g., a mobile application 68 running on a smart phone or other mobile device of a user 12) receives 106 a command from a user 12. Typically, this command may be received 106 as a voice command. Accordingly, a client device 16 may convert the command from speech to text (or leverage functionality of an operating system 40 to convert the command from speech to text) and then interpret 108 the command. If the command comprises a request to navigate to a destination, the client device 16 may search 110 a database, one or more tables, or the like to find the destination. As a result, a client device 16 may determine 112 whether the destination corresponding to the command is an identifiable destination within the system 10.

If the destination corresponding to the command is not found in the database, one or more tables, or the like, the client device 16 may inform 114 the user 12 that the destination is not found. This may give the user 12 the opportunity to learn (e.g., hear back) how the client device 16 interpreted his or her command. Accordingly, the user 12 may repeat or rephrase a command or issue a different command as he or she thinks best.

If the destination corresponding to the command is found in the database, one or more tables, or the like, the client device 16 may build 116 a navigation instruction set and then inform 118 the user 12 that what follows are “navigation instructions to . . . ” the particular destination. This may give the user 12 the opportunity to learn (e.g., hear back) how the client device 16 interpreted his or her command. Accordingly, the user 12 may repeat or rephrase a command or issue a different command as he or she thinks best. Alternatively, if the client device 16 properly interpreted the command, the user 12 may listen as the client device 16 conducts 120 a sequential delivery of the navigation instruction set.

A navigation instruction set may rely on one or more types of navigation aids. For example, a navigation instruction set may rely on GPS data and GPS-based instructions for navigating an outdoor portion of a route toward the destination. However, as the route toward the destination transitions from an outdoor environment to an indoor environment, the navigation instruction set may transition to relying on radio tags 18 and radio-tag-based instructions for continuing to navigate within the building toward the destination. Thus, a system in accordance with the present invention may support or generate navigation instruction sets that are entirely GPS based, entirely radio-tag based, or based on combined arrangement employing both GPS-based instructions and radio-tag-based instructions.

As a user 12 moves through a space 86 (e.g., an indoor space), a reading device 14 corresponding to the user 12 may encounter transmissions issued by one or more radio tags 18. One example of such a process is illustrated in FIG. 17, which shows how a client device 16 (e.g., a mobile application 68 running on a smart phone or other mobile device) may interact with software (i.e., a “Cane Application”) running on a computer processor (e.g., a microprocessor) associated with a cane 58 and the reading device 14 corresponding thereto and how that software (i.e., the “Cane Application”) may interface with a RFID reader that is also associated with the cane 58 and the reading device 14 corresponding thereto.

Various techniques may be used to determine which transmission (and hence which radio tag 18) corresponds to a current location of the user 12. For example, read count may be used to determine which radio tag 18 is closest to a reading device 14. Typically, the higher the read count, the closer the radio tag 18. Alternatively, or in addition thereto, received signal strength indicator (RSSI) may be used to determine which radio tag 18 is closest to a reading device 14. In certain implementations, historical data (e.g., which radio tags 18 did the user 12 recently pass) may also be factored in when determining which radio tag 18 is now closest to a reading device 14.

By determining which radio tag 18 is currently closest to a reading device 14, a client device 16 may determine where a user 12 is in his or her progression to a destination. This may enable a client device 16 to determine when it is appropriate or necessary to issue a next instruction from the navigation instruction set. For example, when a user 12 draws near a radio tag 18, a client device 16 may determine that it is time to issue a command to “turn left and walk ten paces down the hall” or the like.

By determining which radio tag 18 is currently closest to a reading device 14, a client device 16 may also determine whether a user 12 has significantly departed from the path set forth in the navigation instruction set. Accordingly, when such a departure is detected 122, the client device 16 may build 116 a revised navigation instruction set and inform 118 the user 12 that it is “recalculating navigation instructions to . . . ” the particular destination. This may give the user 12 the opportunity to learn that he or she has moved off course, but that the client device 16 is making the necessary adjustments to correct the problem. A client device 16 may continue to conduct 120 a sequential delivery of navigation instructions until a user 12 reaches a destination, a new command is received 124 (e.g., a command corresponding to a new destination) from a user 12, or the like.

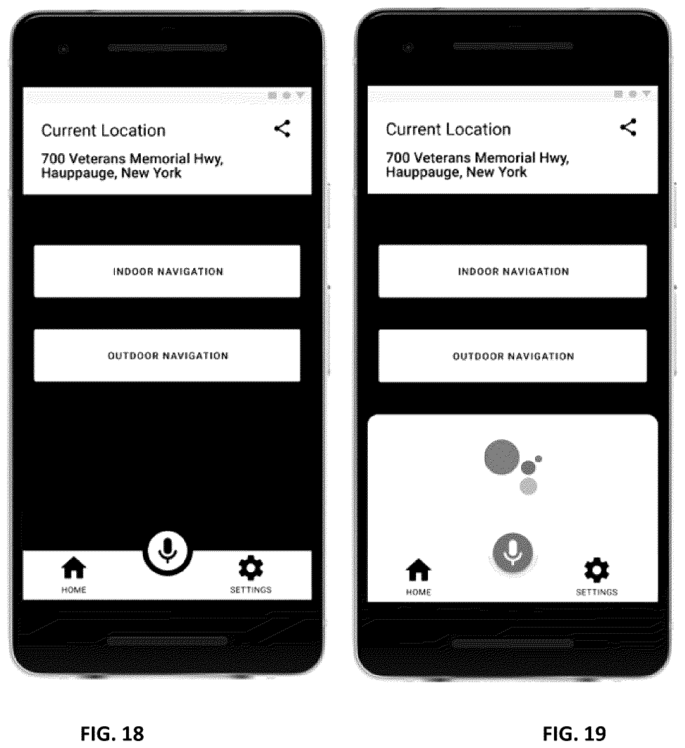

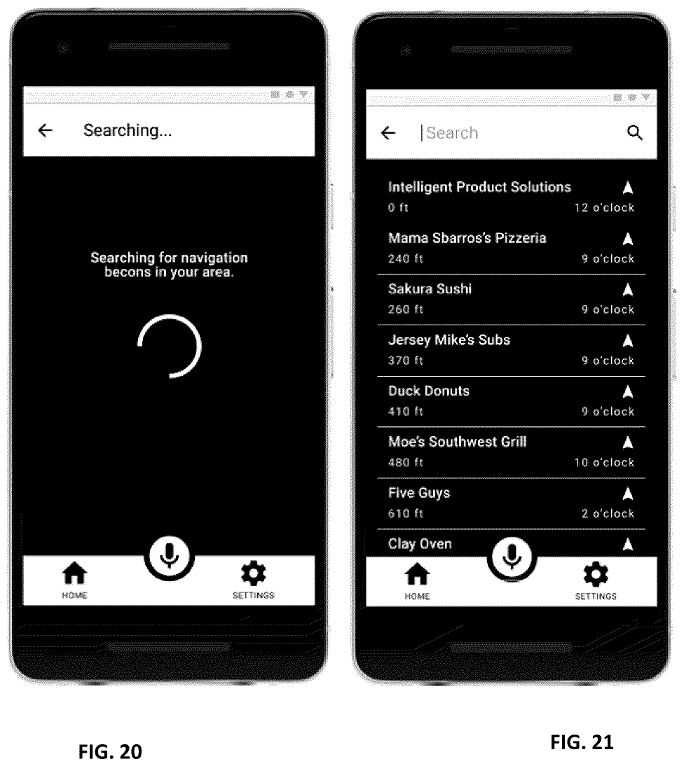

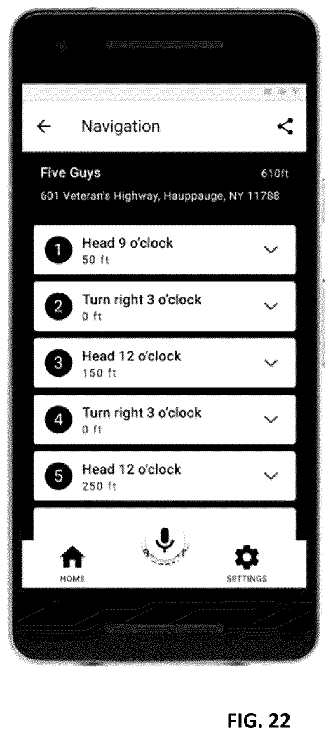

Referring to FIGS. 18-22, various screen shots are provided of one embodiment of a user interface of a mobile application 68 running on a client device 16. For example, FIG. 18 provides a screen shot of a home screen of a user interface of the mobile application 68. FIG. 19 provides a screen shot of the user interface as a voice command is being received by the mobile application 68. FIG. 20 provides a screen shot of the user interface as the mobile application 68 searches for information or data that may be responsive or relevant to a voice command received from a user 12. FIG. 21 is a screen shot of the user interface as the mobile application 68 presents a listing of results (e.g., potential destinations) that may be responsive or relevant to a voice command received by the mobile application 68. FIG. 22 is a screen shot of the user interface as the mobile application 68 presents a navigation instruction set that will direct a user to a particular destination.

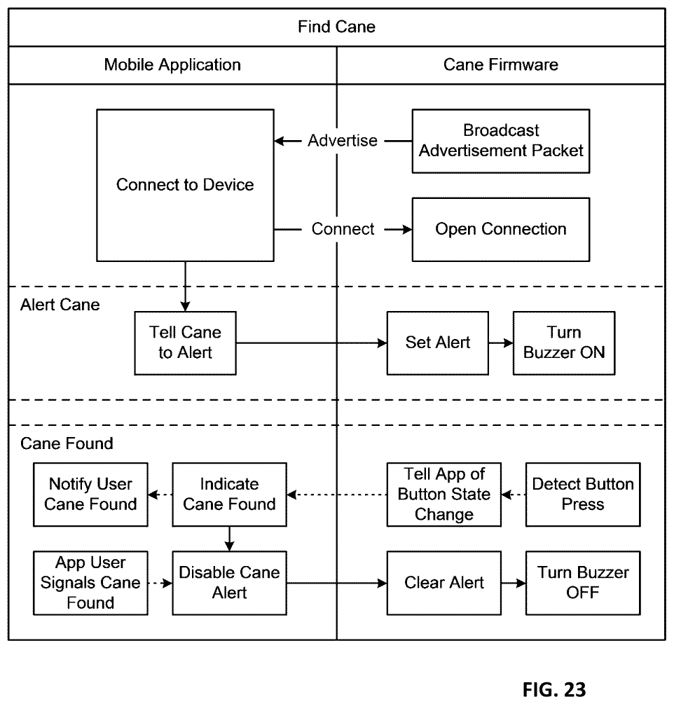

Referring to FIG. 23, in selected implementations, a client device 16 (e.g., a mobile application 68 running on a smart phone or other mobile device of a user 12) may support certain helpful functionality. For example, a client device 16 may support a cane-locating process that may assist a user 12 in locating a cane 58 that comprises or is connected to a reading device 14.

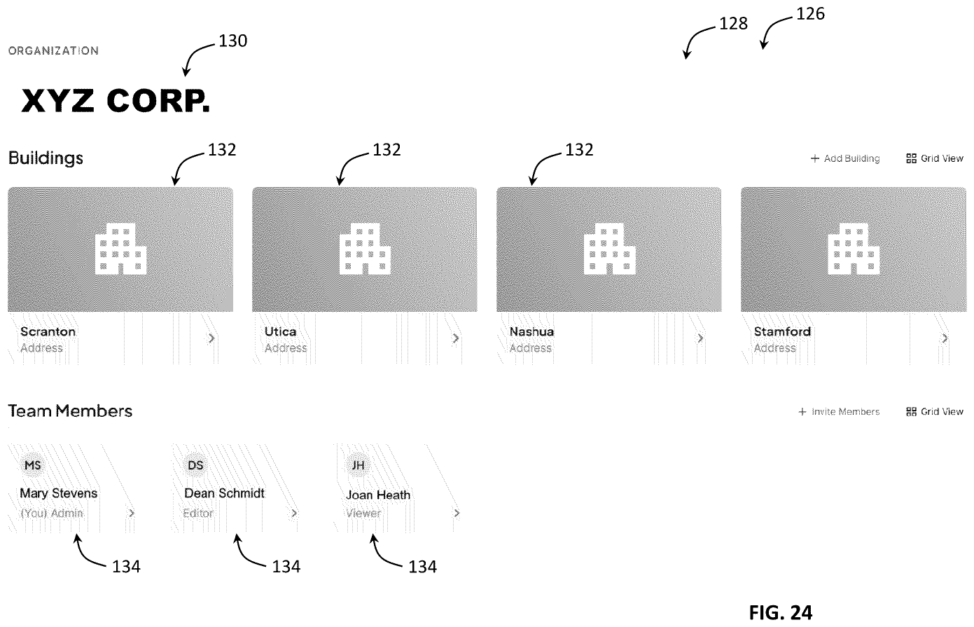

Referring to FIG. 24, in certain implementations, a system 10 may include or benefit from (e.g., use the output of) a build-out application 126. A build-out application 126 may run or be stored on a server 70 or other computing device or system. A build-out application 126 may include or present a user interface 128. Through the user interface 128, one or more individuals may be able to add, edit, or delete information, access different files, or otherwise build-out data that may assist or enable a system 10 to provide navigable routes for a user 12 of the system 10.

In selected implementations, a user interface 128 may present, identify, or enable one or more individuals to navigate to an organization 130 or the files corresponding to an organization 130. Accordingly, each organization 130 may be treated as a separate object. The user interface 128 may identify one or more buildings 132 corresponding to the organization 130. Accordingly, each building 132 may be treated as a separate object. Through the user interface 128, one or more individuals may access data corresponding to one or more buildings 132, add one or more buildings 132, or edit data corresponding to one or more buildings 132.

A user interface 128 may list or identify one or more team members 134, enable an administrator to add, edit, or delete information corresponding to one or more team members 134, or the like. A team member 134 may be an individual authorized to access the build-out application 126. Thus, team members 134 may have different responsibilities, different authorizations, or the like as they navigate through or otherwise use the build-out application 126.

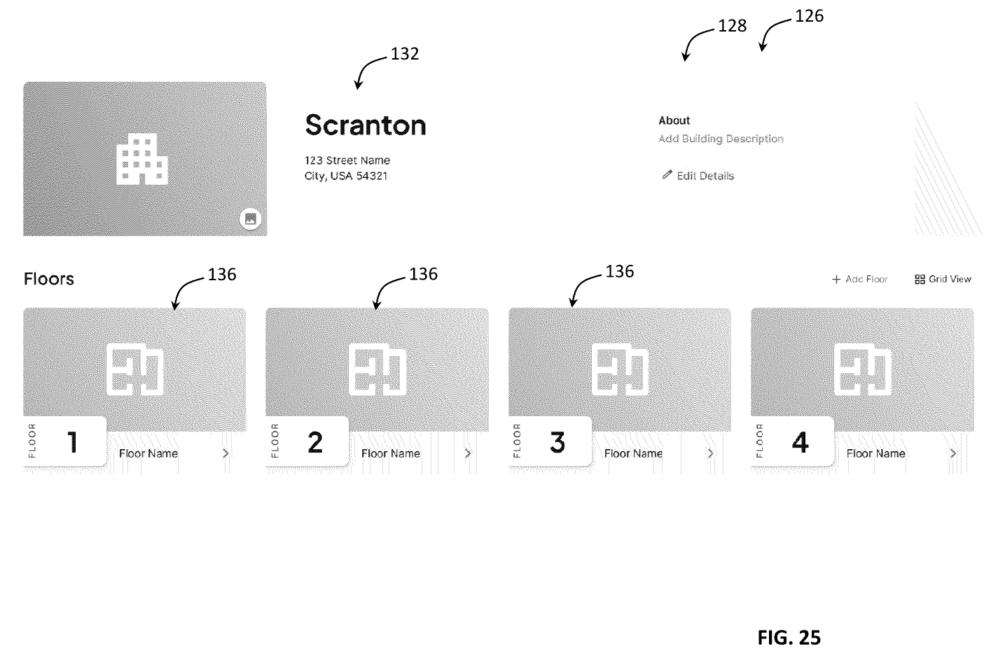

Referring to FIG. 25, when a team member clicks on or otherwise accesses a building 132, the user interface 128 may present data corresponding to the building 132. For example, the user interface 128 may present one or more sections or portions of the building 132. In certain implementations, these sections or portions may be floors 136 of the building 132. Thus, within the user interface, a team member may add a floor 136 or edit or view data corresponding to a floor 136. Accordingly, each of the one or more floors 136 or other sections or portions of a building 132 may be treated as separate objects.

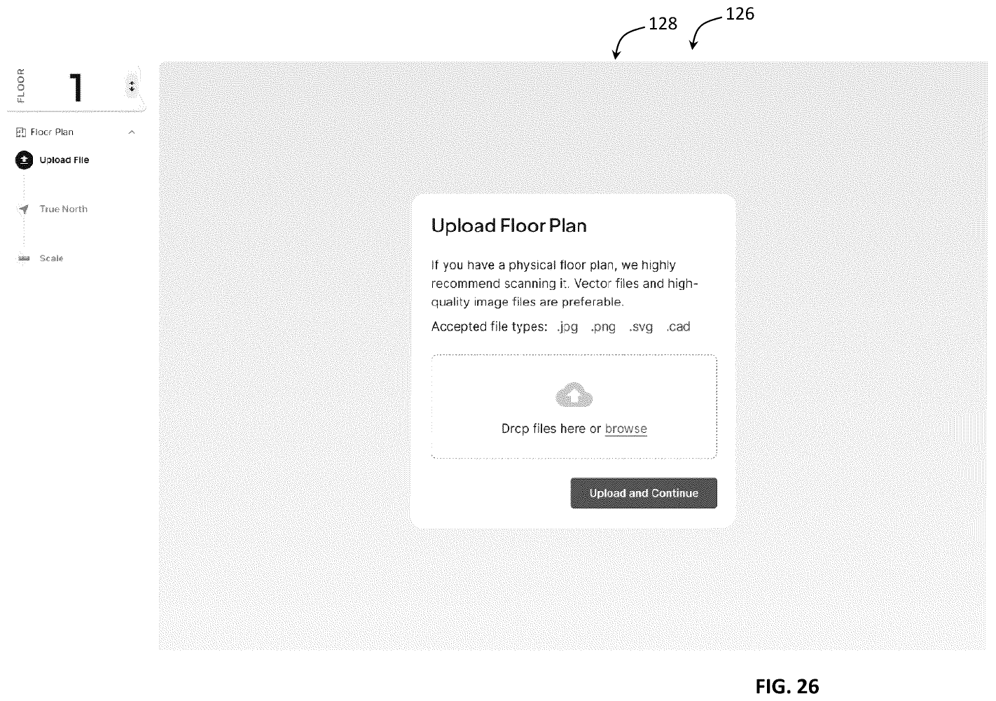

Referring to FIG. 26, when a team member adds a floor 136 that has not previously been created within the build-out application 126, a user interface 128 may guide the team member 134 through a process for setting up the floor 136. This process may include uploading a floor plan 138. Thus, a team member 134 may upload an image (e.g., a JPEG image or the like) depicting a floor plan 138.

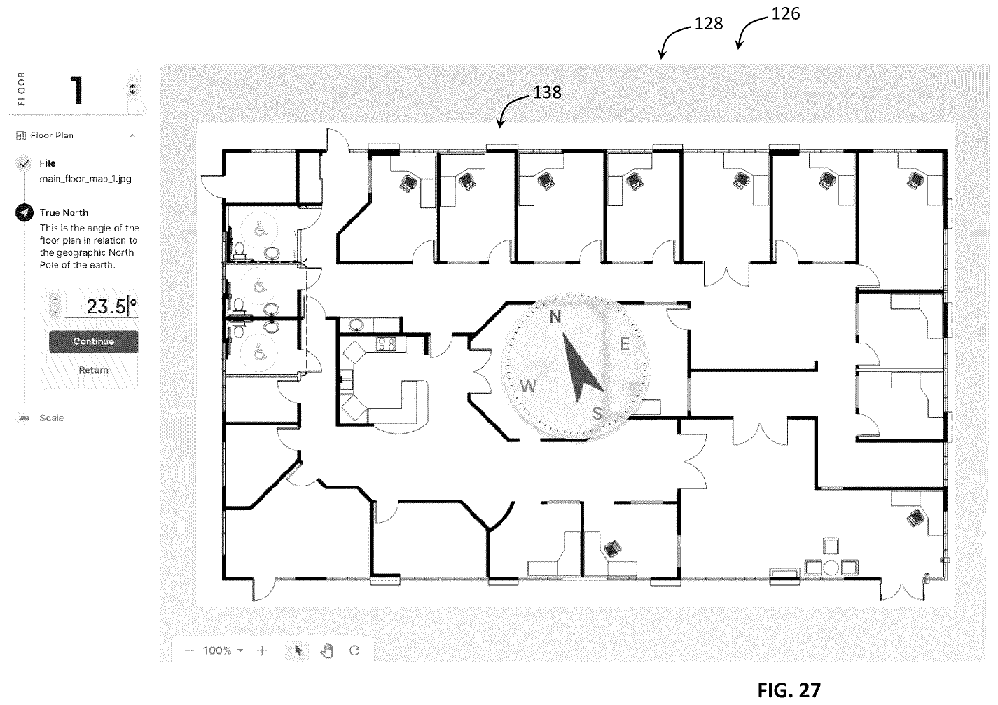

Referring to FIG. 27, once the team member 134 has uploaded the floor plan 138, the user interface 128 may prompt the team member 134 to identify an orientation of the floor plan 138 with respect to true north. That is, the user interface 128 may prompt the team member 134 to identify the angle of the floor plan 138 in relation to the geographic North Pole of the earth. Because the system 10 may know the orientation of the floor plan 138 with respect to true north, orientation information (e.g., data from a digital compass on a reading device 14 and/or client device 16 carried by a user 12) may be used to facilitate or improve the navigation information or instructions that may be provided by the system 10 to the user 12.

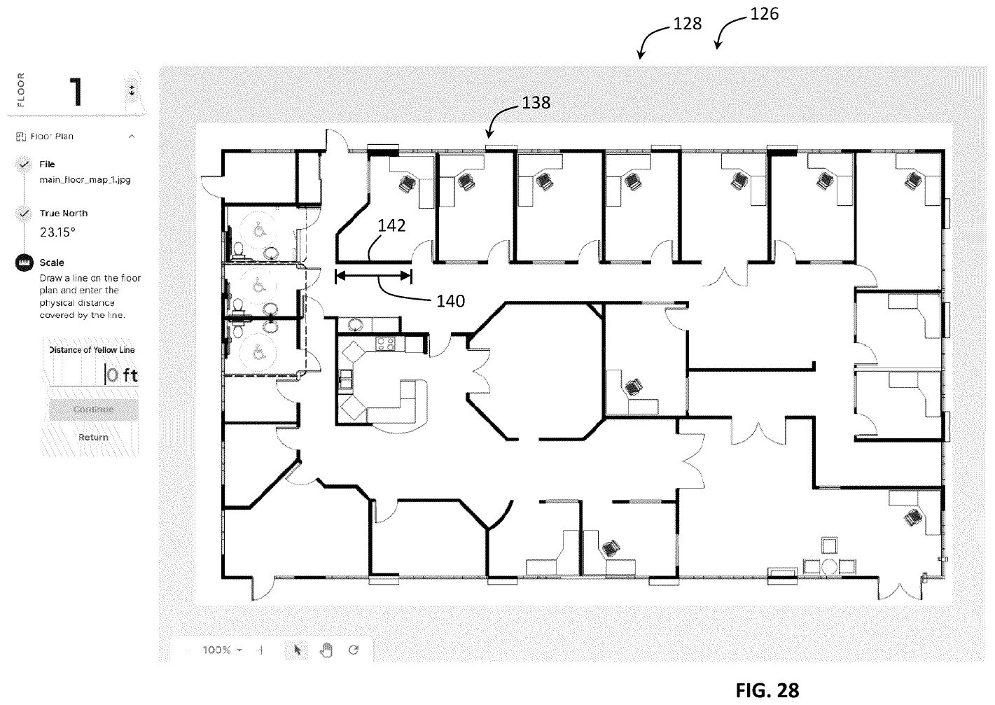

Referring to FIG. 28, a user interface 128 may guide a team member 134 through a process of determining or identifying a scale of the floor plan 138. This process may include drawing a line 140 or the like along a particular portion of the floor plan 138. Thereafter, the team member 134 may enter or otherwise identify the length of the line 140 if it were placed in the building 132.

For example, within the user interface 128, the team member 134 may draw a line 140 over the floor plan 138 along a wall segment 142. That is, the length of the line 140 may be identical to the length of the wall segment 142 as illustrated in the floor plan 138. The team member 134 may then enter the actual length of the wall segment 142. Thus, the build-out application 126 may learn from the team member 134 the orientation and/or scale of the floor plan 138. This may enable the build-out application 126 to know or calculate the true orientation, relative orientation, and spacing between any element the team member 134 may thereafter add or superimpose on the floor plan 138.

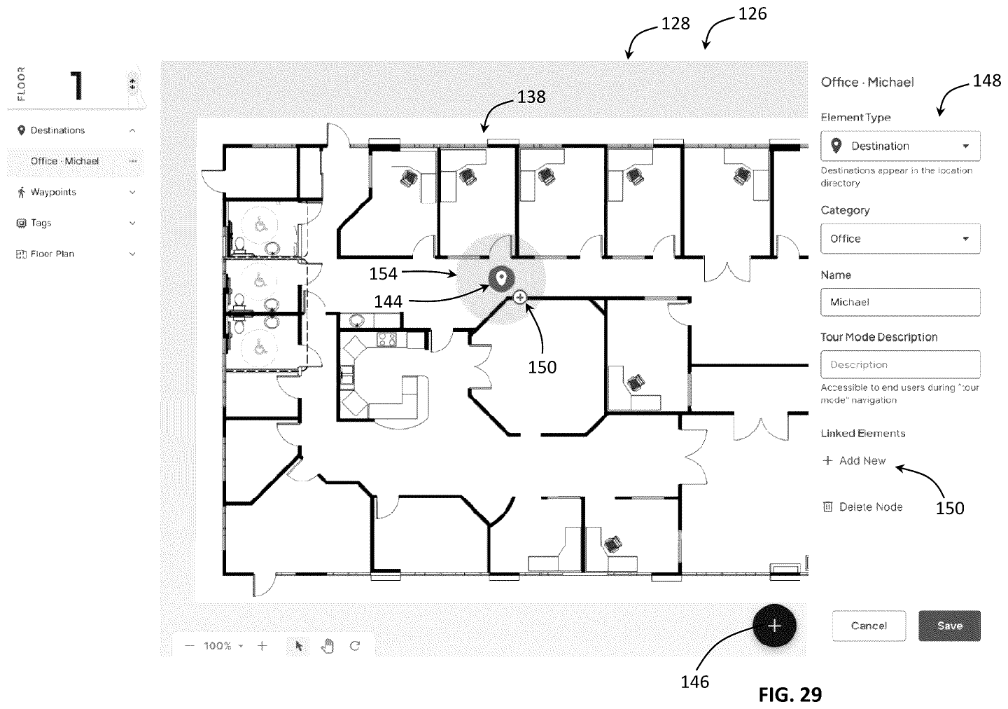

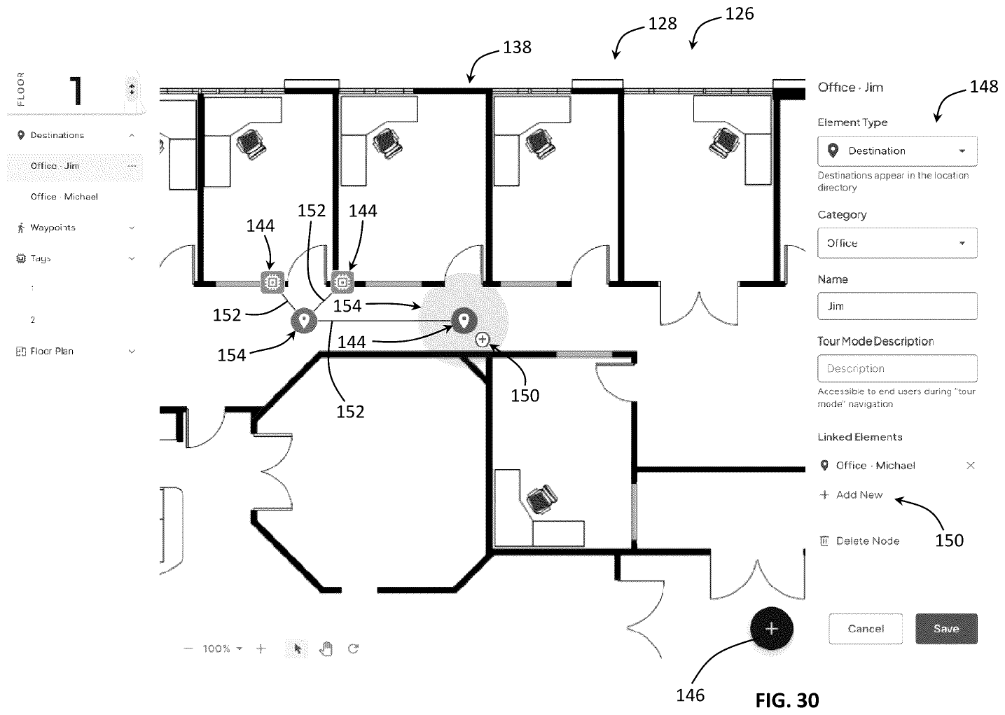

Referring to FIGS. 29 and 30, once a floor plan 138 has been uploaded, oriented, and scaled, one or more elements 144 may be applied or superimposed onto the floor plan 138. This may be accomplished by selecting a new element button 146. When a new element button 146 is selected, an element 144 may appear on a floor plan 138. A team member 134 may then move the element 144 to a desired location on the floor plan 138. Additionally, the team member 134 may enter element data 148 that characterizes the element 144.

With each of the one or more floors 136 or other sections or portions of a building 132 being treated as separate objects, a build-out application 126 may enable the elements 144 to be tied to each such object. Thus, the elements 144 may be independently definable and/or namable and the team members 134 may navigate down through a building object and a floor object and see the floor plan 138 and create, assign, edit, or delete the elements 144 corresponding thereto.

Element data 148 may include an element type, category, name, tour mode description, or the like or a combination or sub-combination thereof. The type of an element 144 may be either a node or a location aid. A node may form part of a navigation route or path. Accordingly, as a user 12 follows the instructions provided by a system 10, the user 12 may pass over or through each node corresponding to that navigation path. In certain implementations, a node may be a destination, waypoint, or the like. A location aid may be a type of element 144 that does not form part of a navigation path. Accordingly, as a user 12 follows the instructions provided by a system 10, the user 12 will not typically pass over or through any location aids. A location aid may be an element 144 that represents a radio tag 18.

A destination may be a location to which a user 12 may desire to navigate. Accordingly, if an element 144 is identified as a destination, then that destination may appear in a location directory and the user 12 may issue a command to navigate to a location corresponding to the element 144.

A waypoint may be or correspond to a location, but have different characteristics than a destination. For example, a waypoint may not appear in a location directory. Thus, a user 12 may be unable to navigate to a waypoint. Rather, the user 12 may travel through a waypoint to reach a desired destination. Accordingly, a waypoint may assist in navigation (e.g., enable a system 10 to verify whether a user 12 is still on course), but be somewhat or entirely transparent as far as the user 12 is concerned.

In certain implementations, elements 144 of different types may be illustrated on a floor plan 138 using different icons. For example, elements 144 that are destinations may be illustrated as a map-marker icon. Elements 144 that are waypoints may be illustrated with an icon showing a person walking. Elements 144 that are radio tags 18 may be illustrated with a simplified or schematic view of a radio tag 18. Thus, a team member 134 working within the build-out application 126 may easily and at a glance distinguish which elements 144 are of which type.

A category may provide general information about the element 144. For example, the category may indicate that the element 144 is an office. In other implementations or situations, the category may be set to restroom, men's restroom, women's restroom, elevator, stairs, kitchen, water fountain, escalator, doorway, entrance, exit, exit/entrance, inside threshold (indicating that a user 12 is at an inside threshold of a door), outside threshold (indicating that a user 12 is at an outside threshold of a door), hazard (indicating that certain potentially hazardous or disruptive activity such as construction is happening proximate the location), or the like or any other desired category. In selected implementations, the element data 148 may include both a category and a subcategory, thereby increasing the amount and/or granularity of the information provided. For example, a category may be set to restroom and the subcategory may be set to men's restroom, women's restroom, family restroom, unisex restroom, etc. Alternatively, a category may be set to food and the subcategory may be set to kiosk, vending machine, restaurant entrance, grocery store entrance, etc.

A name within the element data 148 may provide a unique identifier corresponding to the element 144 at issue. For example, if the element 144 is a destination and the category is an office, then the name may correspond to or identify an individual assigned to the office. In the element 144 illustrated in FIG. 29, the name corresponding to the element 144 is “Michael.” Thus, when a user 12 selects or voices a desired destination, the user may indicate that he or she would like to “navigate to Michael's office” and, due to the element data 148, the system 10 may identify the appropriate destination and render an appropriate set of instructions that will enable the user 12 to reach that destination.

In certain implementations, tour mode description may correspond to or comprise information (e.g., text) that describes something about the location. For example, the tour mode description may be one or more sentences that may be read (e.g., by text-to-speech functionality provided by a system 10) to a user 12 as the user 12 passes that location. This may provide or facilitate an informational tour of the corresponding portion (e.g., floor 136) of the building 132.

In certain implementations, the element data 148 may include an add-linked-element button 150. Alternatively, or in addition thereto, an add-linked-element button 150 may appear or be placed on a floor plan 138 proximate an element 144 that is active or currently selected. Selection or activation of an add-linked-element button 150 may create another element 144 that is linked to the element 144 that was active or previously selected. A line 152 (e.g., a line representing a link) may extend between the elements 144 that are linked together. The line 152 may show or visually indicate that an element 144 is linked to another element 144 and, when the elements 144 linked together are nodes (e.g., destinations, waypoints, or the like or combinations thereof), that a user 12 is able to navigate (e.g., walk or otherwise move his or her person) between the corresponding locations in the building 132. Accordingly, elements 144 that are nodes should not be directly linked together when some aspect of the building 132 (e.g., a wall or the like) would prevent a user 12 from traveling directly from one location to the other location.

In selected implementations, an element 144 that is active or currently selected may have an element zone 154 illustrated thereabout. An element zone 154 may identify a region within which one or more radio tags 18 or the like that are linked to the element 144 may be positioned. The element zone 154 may be scaled with respect to the floor plan 138. This may enable a team member 134 using the build-out application 126 to identify permissible locations for securing a radio tag 18 or the like. The element zone 154 may be scaled according to the nature of the technology involved. For example, in the illustrated implementations, the element zone 154 may be scaled or sized to accommodate radio tags 18 that utilize passive RFID technology.

When the elements 144 linked together are a node (e.g., a destination, waypoint, or other type of element 144 that forms part of a navigation path) and a location aid (e.g., an element 144 representing a radio tag 18), then the line 152 and the link represented thereby are an indication that the system 10 will use a sensing of the radio tag 18 (e.g., a receipt of a serial number or the like that is unique to the radio tag 18) as an indication that the user 12 is at the node (i.e., the destination, waypoint, or other type of element 144 that forms part of the navigation path). Accordingly, the location within a floor plan 138 where a team member 134 places an element 144 representing a radio tag 18 should match the location where the radio tag 18 is placed in the building 132 in the real world.

A location of an element 144 representing a radio tag 18 may be spaced some distance from the element 144 (e.g., destination, waypoint, or other node) that is linked thereto. For example, one or more radio tags 18 may be secured to the base board extending along a wall, while one or more nodes corresponding to the radio tags 18 may be centered within a hallway or the like. Due to this spacing or offset, a user 12 need not travel from radio tag 18 to radio tag 18 regardless of whether the radio tags 18 are in sub-optimal walking locations or periodically shift from one side of a hallway to the other. Rather, the user 12 may walk a more optimal path (e.g., a path down the center of a hallway or the like) defined by the nodes. The spacing or offset between the radio tags 18 and the location of a node linked thereto is known within the build-out application 126. Accordingly, the spacing or offset may be ignored if it is negligible or has no negative impact on the experience of the user 12. Alternatively, if the spacing or offset is relatively large or significant in any way, the spacing or offset may be factored into one or more calculations used in delivering a navigation path to a user 12.

The element data 148 for elements 144 representing the radio tags 18 may be different from the element data 148 corresponding to elements 144 representing the nodes. In particular, the element data 148 for an element 144 representing a radio tag 18 may include the unique serial number or the like stored within, and transmitted by, the radio tag 18.

In certain implementations, an element 144 representing a destination, waypoint, or other node, may be linked to one or more elements 144 that each represent a radio tag 18. For example, as illustrated, the element 144 representing a destination outside the office corresponding to Michael is linked to two different instances of an element 144 that represents a radio tag 18. One of the elements 144 is positioned on one side of the door of the office and another of the elements 144 is positioned on an opposite side of the door. These two elements 144 may store the same serial number. Accordingly, in selected implementations, the system 10 may not distinguish between the two elements 144 as a user 12 navigates through or past the corresponding node. Alternatively, the radio tags 18 may each store a different serial number. Accordingly, in other implementations, a system 10 may collect or utilize more information as a user 12 navigates through or past the node. For example, the order in which the user 12 encounters the radio tags 18 may be used to identify a direction of travel. Alternatively, relative signal strength, signal directionality, or the like between or among the two radio tags 18 may enable the system 10 to perform or utilize precise calculations with respect to the current location of a user 12, deviations from a navigation path, or the like.

In selected implementations, a build-out application 126 may facilitate transmission or receipt of a unique serial number to or from one or more radio tags 18. For example, when an element 144 representing a radio tag 18 in the build-out application 126 is created in the build-out application 126, the build-out application 126 may automatically generate a unique serial number for that element 144. Thereafter, a computer device (e.g., a mobile device) linked to, associated with, or running the build-out application 126 may be used to program the unique serial number within the radio tag 18. That is, a team member 134 may select a radio tag 18 (e.g., select a radio tag 18 that has been installed in the building 132 or is ready to install in the building 132) and use the computer device to pass the unique serial number from the build-out application 126 to the radio tag 18.

Alternatively, a team member 134 may select a radio tag 18 (e.g., select a radio tag 18 that has been installed in the building 132 or is ready to install in the building 132), use the computer device to read the unique serial number stored within the radio tag 18 and enter that unique serial number into the build-out application 126 within the element data 148 corresponding to the element 144 representing the radio tag 18. Thus, in such implementations, regardless of which direction a unique serial number is moving, human error associated with manually entering the unique serial number may be avoided.

By selectively placing one or more elements 144 (e.g., one or more nodes representing destinations, waypoints, or the like and one or more location aids representing the radio tags 18) at various locations and with appropriate spacing within a floor plan 138 (e.g., with nodes being separated by about 3 to 5 steps or paces of a user 12), a team member 134 may build out or assist in building out various navigable paths through that portion of the building 132. Accordingly, a team member 134 may continue to position the elements 144 until all navigable paths have been adequately charted and the links between the elements 144 (e.g., between nodes, between nodes and location aids, or the like) have been established. Such work may document or record where one or more radio tags 18 are installed within a building 132. Alternatively, such work may provide instructions or guide one or more installers as they install one or more radio tags 18 within the building 132. Thus, the build-out application 126 may provide a model of a desired or actual build out.

Once a build out is complete and the corresponding location aids are installed in the building 132, a system 10 may enable a user 12 to navigate through the building 132 to any desired destination. In operation, when a user 12 first encounters a building 132 (e.g., a reading device 14 of the user 12 first encounters a radio tag 18 of the building 132) or requests a navigation path to a destination within the building 132, a client device 16 may request and receive from a server 70 all of the data necessary to perform navigation through the building 132. For example, upon encountering a radio tag 18 of a building 132 (e.g., a radio tag 18 near an entrance to the building 132), a client device 16 may pass a serial number (e.g., a unique serial number) associated with the radio tag 18 to the server 70. The server 70 may return data defining all the nodes, location aids, links between nodes and/or location aids, and the like. Using that data, the system 10 may generate or refine a navigation path through the building 132. In selected implementations, the navigation path may be defined at rendering using a Dijkstra Algorithm or the like.

The techniques described herein may relate to a method of generating navigation data. Such a method may include: presenting, by a software application, an image depicting a floor plan of a building; using a user interface of the software application to position a first element at a first location on the image and define the first element as a first waypoint or a first destination; using the user interface to position a second element at a second location on the image, establish a link between the first element and the second element, and define the second element as a second waypoint or a second destination; using the user interface to position a third element at a third location on the image, establish a link between the first element and the third element, and define the third element as a radio tag having an identifier; defining, by the software application within the navigation data, the link between the first element and the second element as a human-navigable path; and defining, by the software application within the navigation data, the link between the first element and the third element as a location indicator establishing that receipt of the identifier from a user in a real-world environment indicates that the user is at a real-world location corresponding to the first location.

In certain implementations, the first location may be centrally located within a hallway depicted in the floor plan. Similarly, the second location may be centrally located within the hallway. The third location may be on a wall that at least partially defines the hallway. Thus, the locations for radio tags or other location aids may be spaced from one or more nodes forming waypoints, destinations, or the like of a navigation path.

In selected implementations, the method may further include serving the navigation data to a mobile device located proximate or within a real-world version of the building. Alternatively, or in addition thereto, the method may include building out the real-world aspects of the system. For example, the method may include placing a passive RFID tag within a real-world version of the building at a location that corresponds to the third location. The passive RFID tag may be configured to transmit the identifier upon interrogation (e.g., when activated by electromagnetic radiation originating from a reading device 14).

In certain implementations, the techniques described herein relate to a system that may include: a processing system (e.g., one or more processors); memory operably connected to the processing system; and instructions stored within the memory. The instructions, when executed, may cause the processing system to: present an image depicting a floor plan of a building; enable a user to position a first element at a first location on the image and define the first element as a first waypoint or a first destination; enable the user to position a second element at a second location on the image, establish a link between the first element and the second element, and define the second element as a second waypoint or a second destination; enable the user to position a third element at a third location on the image, establish a link between the first element and the third element, and define the third element as a radio tag having an identifier; generate navigation data in which the link between the first element and the second element is defined as a human-navigable path (e.g., a path along which a system 10 may direct a user 12 during a navigation process, a path that does not cross any barriers that would prevent a user 12 from traveling along the path during a navigation process, or the like); and define, within the navigation data, the link between the first element and the third element as a location indicator establishing that receipt of the identifier from a user in a real-world environment indicates that the user is at a real-world location corresponding to the first location.

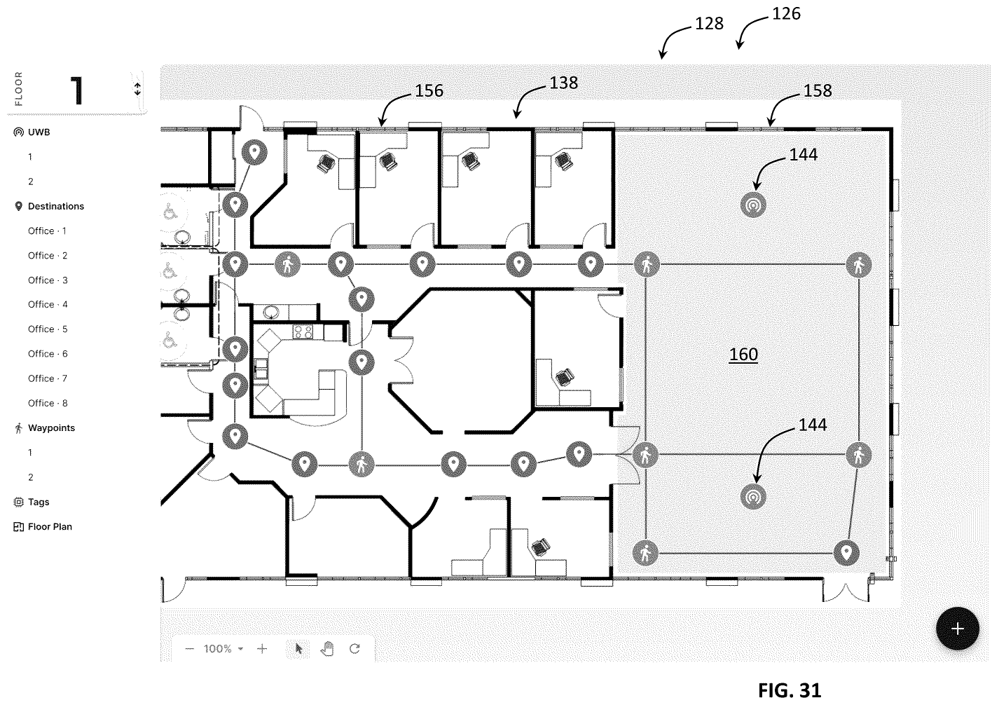

Referring to FIG. 31, in certain implementations, a floor plan 138 may include a first portion 156 having spaces that are narrower or confining and that are, therefore, well suited to the use of location aids such as radio tags 18 applied to walls, base boards, door jams, or the like. Alternatively, or in addition thereto, a second portion 158 of a floor plan 138 may have a different configuration. For example, the second portion 158 may include an open space 160 with few walls or the like suited to receive a radio tag 18 applied thereto. Accordingly, in selected implementations, one or more elements 144 suited to be a location aid across a wider area may be used. For example, elements 144 representing beacons (e.g., BLE beacons, ultra- wide band (UWB) beacons, or the like) that are actively powered and capable of transmitting signals over longer distances may be used. Such beacons may be used (e.g., signals sent by such beacons may be used by a reading device 14, client device 16, or the like) to determine the location and/or orientation of a user 12 using triangulation, signal strength calculations, signal directionality, or the like.

In selected implementations, a build-out application 126 may enable a team member 134 to position the one or more elements 144 representing beacons within a floor plan 138. Similarly, a team member 134 may position the one or more elements 144 representing nodes such as destinations or waypoints within an open space 160. Using signals received from one or more beacons, a system 10 may determine where a user 12 is within an open space 160. Accordingly, a build out with elements 144 representing nodes may enable the system 10 to provide instructions directing the user 12 to cross, move through, or otherwise navigate the open space 160.

Alternatively, in a build-out application 126, elements 144 representing nodes such as destinations and waypoints need not always be linked to elements 144 representing location aids. This may apply to areas such as open spaces 160 for which radio tags 18 are not well suited and/or for areas where feedback on a precise location of a user 12 is not available (e.g., where a beacon can provide some feedback on a location of a user 12, but without the granularity or precision that may be available using radio tags 18). Accordingly, in operation, when a user 12 encounters an area (e.g., an open space 160) not well suited to radio tags 18 or where less precise feedback on position is available, the system 10 may use the build out of nodes and assume that the user 12 is accurately following the provided navigation instructions until it receives feedback or data indicating otherwise, at which point corrective or updated instructions may be provided to the user 12 as necessary.

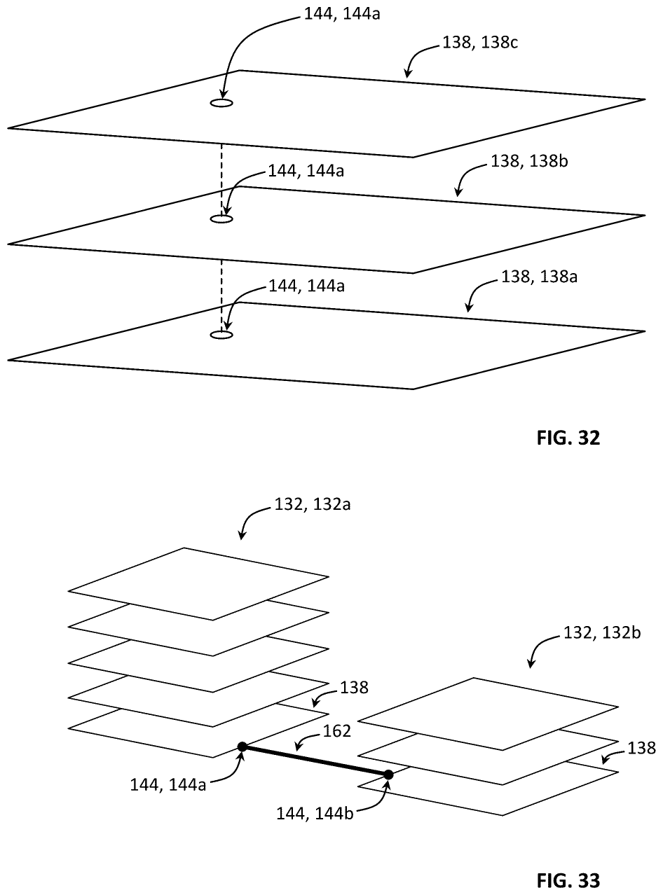

Referring to FIG. 32, in certain implementations, a build-out application 126 may support or enable an element 144 comprising or representing a portal. For example, the element data 148 corresponding to one or more elements 144 may indicate that the one or more elements 144 are of a “portal” type. While an element 144 representing a destination, waypoint, location aid (e.g., radio tag 18 or beacon), or the like may be tied or associated with a floor plan 138, an element 144 comprising or representing a portal may be associated with more than one floor plan 138. Thus, two or more floor plans 138 may share an element 144 that forms a portal between the two or more floor plans 138. That is, an element 144 comprising or representing a portal may link two or more floor plans 138 together at that point.

For example, a building 132 may include three floors 136. A first floor plan 138a may correspond to a first floor, a second floor plan 138b may correspond to a second floor, and a third floor plan 138c may correspond to a third floor. Accordingly, a first element 144a comprising or representing a portal may be positioned or assigned within a build-out application 126 to the first floor plan 138a. The first element 144a may also be positioned or assigned within the build-out application 126 to the second floor plan 138b. Additionally, the first element 144a may be positioned or assigned within the build-out application 126 to the third floor plan 138c.

Within a build-out application 126, an element 144 comprising or representing a portal may correspond to or be placed on a floor plan 138 by an entrance or exit of an elevator, stairwell, escalator, skyway, ramp, or the like or any other feature that typically links one portion or floor 136 of a building 132 to another portion or floor 136 of the building 132. Accordingly, the element data 148 corresponding to one or more elements 144 comprising or representing a portal may indicate that the one or more elements 144 are of an “elevator,” “stairwell,” “escalator,” “skyway”, or “ramp” category, sub-category, or the like. In operation, when a user 12 is navigating through the building 132 and reaches the location of the portal, the user 12 may be viewed or treated by the system 10 as simultaneously residing in each of the first floor, the second floor, and the third floor. In such an arrangement, as the user 12 approaches the portal, the system 10 may issue a navigation instruction such as “take the elevator to the second floor,” “take the escalator down to the first floor,” “take the ramp up to the upper deck” or the like.

In certain implementations, a user 12 may specify preferences (e.g., weightings or ranked lists) with respect to one or more portals. For example, a user 12 may use a client device 16 to enter or express a preference for elevators over stairs. Accordingly, when a system 10 renders a navigation path for the user 12, this preference may be taken into consideration. That is, the user 12 may be directed to an elevator rather than to a stairwell when the user 12 needs to move from one floor to another floor. However, in situations where there is no elevator, the system 10 may still direct the user 12 to the stairwell.

Alternatively, or in addition there too, different portals may have different emergency egress settings applied thereto (e.g., selected within one or more categories or sub-categories of the element data 148). For example, in the event of a fire alarm or similar emergency, it may be inappropriate or undesirable to use an elevator. Accordingly, if a user 12 requests navigation to an emergency exit or an emergency evacuation is entered into or initiated by a system 10 (e.g., if a team member 134 or automation converts a fire alarm or the like into a command for users 12 of a system 10 within a building 132 to evacuate the building 132), a system 10 may direct a user 12 to evacuate through one or more portals that are compatible with emergency egress protocols and avoid one or more portals that are incompatible with emergency egress.

In selected implementations, elements 144 comprising or representing portals of a particular variety may be controlled by an administrator rather than by team members 134 associated with an organization 130. For example, in certain situations, a portal such as a skyway may extend to connect a building 132 corresponding to an organization 130 to another building 132 corresponding to another organization 130. Thus, neither may be well suited to control or otherwise set the parameters (e.g., the element data 148) corresponding to the portal. In such situations, an administrator may set the parameters and one or more organizations 130 may then select or use the element 144 in their respective build-out processes.

In certain implementations, orientation data corresponding to a client device 16, reading device 14, or the like may be used to facilitate generating and/or updating a navigation path. For example, when starting navigation, recalculating a navigation path, passing through a location with no location aids, or the like a user 12 may be in an undefined zone where a direction of travel or a direction in which the user 12 is facing may not be immediately apparent to a system 10. In such situations, the system 10 may take no action until the user 12 has moved sufficiently that an orientation or direction of travel of the user 12 becomes known. However, such delay may result in the user 12 advancing some distance in a wrong direction and, thereby, degrade the experience of the user 12.

Accordingly, as set forth hereinabove, an orientation of a floor plan 138 with respect to true north, magnetic north, or the like may be identified during a build-out process facilitated by a build-out application 126. Additionally, orientation data (e.g., compass data from a client device 16, reading device 14, or the like or a combination thereof) may be used to predict an initial orientation or direction of travel of a user 12. This may enable a system 10 to preemptively or more quickly determine whether the user 12 is pointed or moving in an appropriate direction and if not, provide earlier correction so that the user 12 does not waste significant time or effort going in the wrong direction.

Referring to FIG. 33, in selected implementations, a build-out application 126 may support or enable navigation through one or more linking structures 162. A linking structure 162 may link or define a connection between two or more buildings 132 (e.g., two or more buildings 132 or other structures forming part of an academic campus, corporate campus, apartment complex, shopping complex, government complex, downtown environment, or the like). For example, a linking structure 162 may be or include a breezeway, skyway, side walk, side walk system, portion of a side walk system, or the like. Within a build-out application 126, one or more elements 144 may be applied to the linking structure 162. Thus, once created within a build-out application 126 and in the real world, a user 12 may use the system 10 to navigate from a location in one building 132, through the linking structure 162, to a location in another building 132.

In certain implementations, a linking structure 162 may be outside or include an area where the reading device 14 and/or client device 16 may have access to GPS signals. Thus, the system 10 may use location data derived from the GPS signals to navigate a user 12 through the linking structure 162. However, once created within a build-out application 126 and in the real world, navigation using tags 18 may provide a backup option to the use of GPS signals, improved accuracy, a more seamless experience for the user, or the like.

A linking structure 162 may be, include, or correspond to a floor plan 138 (e.g., may be viewed or thought of as a “building 132” with only one floor 136 defined by the floor plan 138). Accordingly, a floor plan 138 for a linking structure 162 may be uploaded and oriented and a scale for the floor plan 138 may be determined using a build-out application 126 as described above. Additionally, using the build-out application, various elements 144 representing destinations, waypoints, location aids (e.g., radio tags 18 or beacons), or the like may be tied or associated with a floor plan 138 corresponding to the linking structure 162.

In selected implementations, multiple instances of an element 144 comprising or representing a portal may be associated with the floor plan 138 corresponding to the linking structure 162. For example, one end of a linking structure 162 may have a first element 144a forming a first portal, while an opposite end of the linking structure 162 may have a second element 144b forming a second portal. Thus, a floor plan 138 corresponding to a first building 132a and a floor plan 138 corresponding to the linking structure 162 may share the first element 144a, which may form a portal between or that links those floor plans 138. Similarly, a floor plan 138 corresponding to a second building 132b and the floor plan 138 corresponding to the linking structure 162 may share the second element 144b, which may form a portal between or that links those floor plans 138. Thus, two or more buildings 132 may be connected via one or more linking structures 162 and a system 10 may enable or provide navigation among the buildings without regard to whether GPS signals are available.

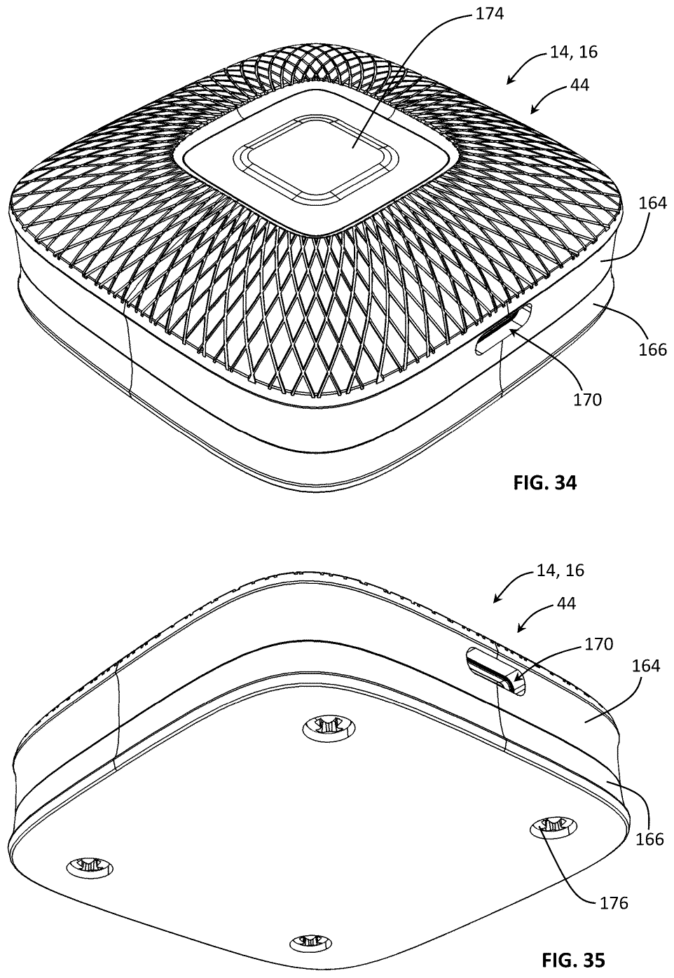

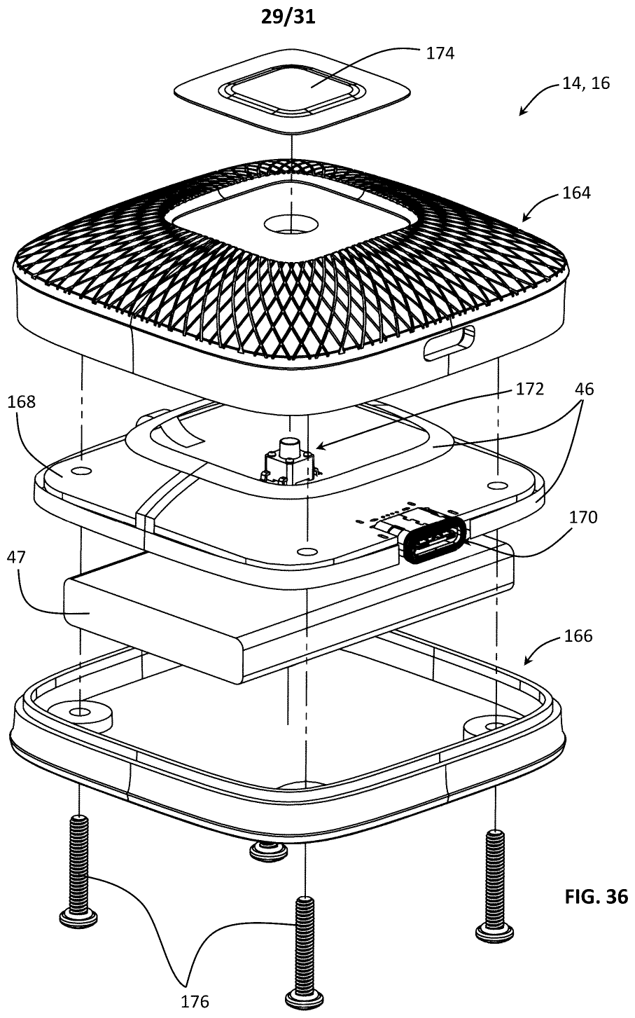

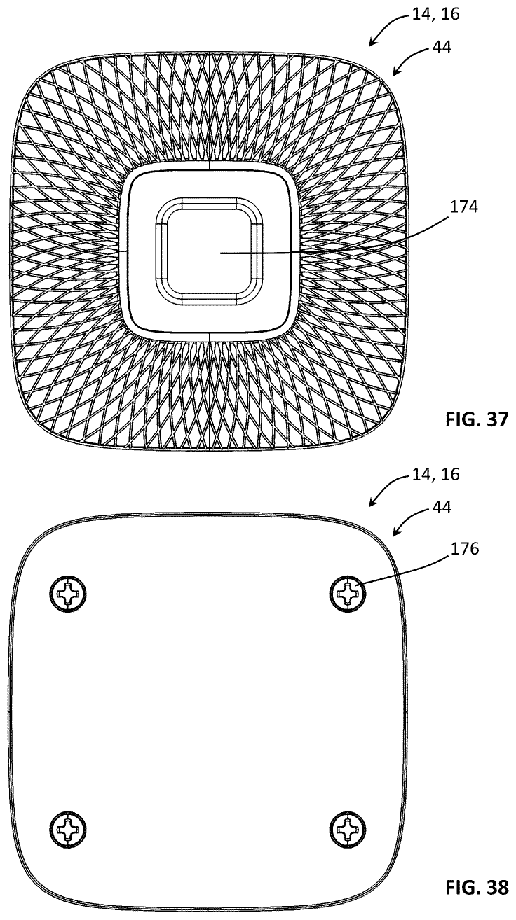

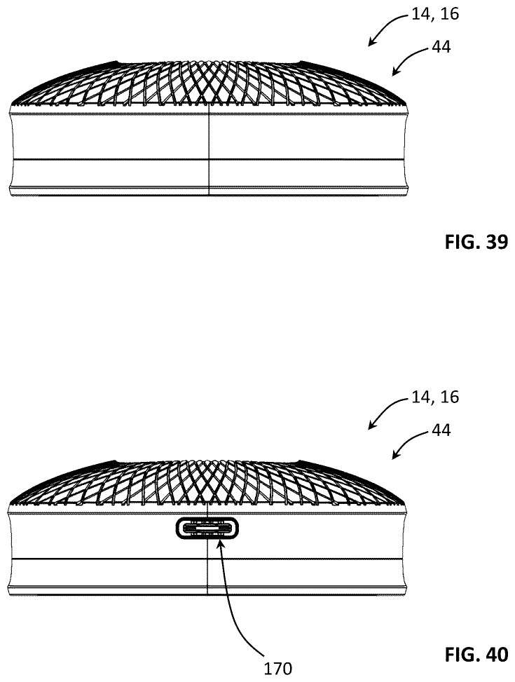

Referring to FIGS. 34-40, a reading device 14, a client device 16, or a reading device 14 incorporating all or some aspects or functionality of a client device 16 may have any suitable form factor. As discussed hereinabove, in selected implementations, a reading device 14 may be configured as a cane. In other implementations, a reading device 14 may be configured more compactly. For example, a reading device 14 may include a reading device housing 44 that forms a compact enclosure.

The reading device housing 44 may include an upper portion 164 and a bottom portion 166. Captured between the upper portion 164 and the bottom portion 166 maybe a printed circuit board 168, one or more processors, one or more memory devices, a tag antenna 46, power source 47, or the like or a combination or sub combination thereof. A port 170 may connect to the printed circuit board 168 and provide a location for passing power (e.g., power to recharge a power source 47) and/or data to the reading device 14. A switch 172 may connect to the printed circuit board 168 and combine with an overlay 174 to provide power “ON” and power “OFF” functionality. One or more fasteners 176 (e.g., one or more screws or bolts) may selectively secure the upper portion 164 to the bottom portion 166.

A reading device 14 contained within a compact enclosure and/or that includes all or some aspects or functionality of a client device 16 may provide functionality beyond what may be provided by a reading device 14 configured as a cane. For example, such a reading device 14 may be more discreet and may be used in a way that is not visible or obvious to others. In certain implementations, a reading device 14 may be secured to or carried on or within the harness of a seeing-eye dog. Alternatively, a reading device 14 may be used by one or more individuals that are not visually impaired. For example, a reading device 14 may be used by emergency medical services, police, fire fighters, evacuees, or the like who need to efficiently navigate through a building 132 that is unfamiliar, obscured by smoke, or otherwise difficult to navigate. Accordingly, in selected implementations, a reading device 14 may include a microphone and a speaker. In operation, an individual may issue a command such as “navigate to Office three hundred one” or “navigate to the nearest emergency exit.” Thereafter, the reading device 14 may issue audible navigation instructions that guide the individual to the desired destination.

In selected implementations, a reading device 14 may assist in monitoring the location of certain individuals within a care facility. For example, a reading device 14 may be secured to the clothing of a patient within a hospital or care center. The reading device 14 may interact with one or more radio tags 18, beacons, or the like and thereby learn its location. Thereafter, the reading device 14 may communicate (e.g., via Wi-Fi, cellular service, or the like) with a server 70 or other computer device and report on a current position of the patient. Should the patient pass through a particular doorway, leave a particular portion of the building 132, or otherwise deviate from a desired activity, the reading device 14 may alert a responsible party so the responsible party may take appropriate action.

### Example Embodiments, Features, and Uses

Selected embodiments of a system 10 in accordance with the present invention or certain components or features thereof may be referred to as “the cane system,” “the cane application,” “the cane,” etc. The cane system may comprise an UHF RFID reader equipped walking cane, assistive device, wearable, or the like that communicates over a BLE link or the like to a cane application on the user's smart phone. The cane application on the smart phone may also connect over the Internet to a webserver containing a tag ID database that contains a list of installed UHF RFID tags along with the associated location coordinates and any other details about the tag location that is deemed informative to the cane users, such as address, business name, office number, adjacent features, etc.

### A. The Cane as a Navigation Tool

Reading UHF RFID tags embedded in the environment may enable a cane reader (or some other assistive device or wearable reader) to assist in determining a current location via a corresponding application query to a database in a Web server (e.g., a database storing tag maps or other information identifying the location of one or more tags). These tag locations may be overlayed in a global mapping application such as Google maps and assist and enhance the location functionality provided by the GPS capability of a smart phone. Based on the user's current location, the system may then provide navigation instructions to the user in order for him or her to get to his or her desired destination. This may be more valuable in high rise urban, indoor and subterranean environments where GPS is either inaccurate or unavailable.

Extra location precision and awareness via audible feedback may be enabled by using either received signal from the tag or tag read rate or a combination thereof to estimate distance of the cane (or some other assistive device or wearable) from the tag. Such techniques may also be used to inform the user whether he or she is approaching towards or receding away from the tag.

Additionally, buildings and environments outfitted with BLE beacons may communicate to the cane application to provide location and navigation assistance to the user. BLE beacons may be tags (e.g., tags powered by coin cell batteries) that identify locations that members of the public may use for location awareness and navigation within any facility.

### B. The Cane as a Frictionless Access Control Tool or Badge

A cane (or some other assistive device or wearable) fitted with an RFID tag that uniquely identifies the user may provide a user with access control functionality to a room or building without requiring the user to present a contact or close proximity badge to a door reader. In this case, the door access would have a UHF RFID enabled reader and, on reading and authenticating the tag ID of the cane, the system may automatically unlock and open the door for the user. This may also open-up government and public facilities to the visually impaired for easier and more secure access. It may also be used for home entry and egress as well, with automatic door locking commanded via the cane.

### C. The Cane to Enable Human Presence Detection

A cane (or some other assistive device or wearable) that is moving or in use may be sensed by one or more radio tags (e.g., one or more BLE beacons) in order to determine a location of a corresponding user. For safety and security applications in a building, it would be good to know if a person is in the building. Additionally, knowing a person's precise location within the building may be beneficial for emergency responders to locate and help evacuate the person (e.g., in the event of a fire). In non-safety applications, human presence detection may enable a building management system to adapt a rooms temperature, lighting, or sound system ambience to the presence of a person with an identifiable cane.

### D. The Cane as a Finder Tool for Tagged Devices and Valuables

A user may use the cane (or some other assistive device or wearable) as a tool to locate items and valuables tagged with UHF tags by the user, items such as keys, wallet, remotes, books, luggage (e.g., luggage moving on a baggage claim carousel or conveyor system), or the like. With a distance estimation algorithm built into the cane software, the system may provide the user with real time audible or other feedback when they are getting either closer to the tagged item or going away from the item. Items may be uniquely identified by the RFID tag ID attached to the item and the user may issue a command to the application to, for example, “find my keys.” The application may then direct the cane to find only the RFID tag associated and attached to the keys and ignore other tags attached to other items.

### E. The Cane as a Secure Key Mechanism for Cane Operation

A cane ID (or an ID corresponding to some other assistive device or wearable) and RFID tag ID may be paired to ensure only the valid owner of the cane may operate the RFID reader and other electronically controlled functions of the cane. In this example, the user may wear an RFID tag that is associated with the cane after the user buys the cane. Once paired, only that user may use the reader functions of the cane. This may also be accomplished via a BLE pairing of the cane to the MAC ID of the user's smart phone, but a wearable RFID tag may be more secure.

### F. The Cane as a Shopping Assistant Tool

In more and more retail applications, items such as apparel are often tagged with UHF RFID tags. Accordingly, a user may use the cane (or some other assistive device or wearable) to read tagged items in a store. In this instance, the cane system may pass the tag ID up to the store ERP system and send a query to that system regarding details such as color, size, pricing, etc. and the store ERP system may send that information back to a cane application corresponding to the user, which may then send the user audible details.

### G. The Cane as a Panic/Emergency Alert Tool

A user with the cane (or some other assistive device or wearable) may use a feature of the cane to alert nearby people of an assault or other critical condition or situation and/or automatically command the user's phone to dial an emergency number (e.g., “911”) for assistance. The cane system may automatically forward precise user location data to the authorities equipped with enhanced capabilities that would be augmented or enhanced with the current or last know tag read location identified by the cane as well as any GPS coordinates available from the smart phone.

### H. The Cane as a People Finding Tool

Visually impaired people using the canes (or some other assistive devices or wearables) may use the system to either sense nearby users or locate and meet up with each other at a set designation located with an RFID tag. How this is done may be with a tag inside each cane that identifies the user for proximity detection or the cane application to alert users to the location of other cane users in that user's friend or associate list. Another method may be that the cane smart phone application sends the cane ID that may be unique and associated with the user along with the read tag ID and timestamp to the cane system webserver and database which can then allow groups to access the where-abouts of each other.

### I. Off-Line Operational mode

For deep indoor and/or subterranean environments where both cellular and GNSS connectivity is not possible the cane system may batch the users desired path information beforehand into the smart phone application, which may then act as a local tag ID database and alert the user to their whereabouts from reading those tags along the path.

### J. Tag Distance Estimation

The cane application may enable calculating tag distance based on tag RSSI and tag read rate. This may enable a user to pinpoint the tag position to within a couple of feet, which may be useful for certain applications such as identifying doorways and the whereabouts of small items, such as keys, phones, wallets, and other small valuables.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method of generating navigation data, the method comprising:
presenting, by a software application, an image depicting a floor plan of a building;
using a user interface of the software application to position a first element at a first location on the image and define the first element as a first waypoint or a first destination;
using the user interface to position a second element at a second location on the image, establish a link between the first element and the second element, and define the second element as a second waypoint or a second destination;
using the user interface to position a third element at a third location on the image, establish a link between the first element and the third element, and define the third element as a radio tag having an identifier;
defining, by the software application within the navigation data, the link between the first element and the second element as a human-navigable path; and
defining, by the software application within the navigation data, the link between the first element and the third element as a location indicator establishing that receipt of the identifier from a user in a real-world environment indicates that the user is at a real-world location corresponding to the first location.

2. The method of claim 1, wherein the first location is centrally located within a hallway depicted in the floor plan.

3. The method of claim 2, wherein the third location is on a wall that at least partially defines the hallway.

4. The method of claim 3, wherein the second location is centrally located within the hallway.

5. The method of claim 1, further comprising serving the navigation data to a mobile device located proximate or within a real-world version of the building.

6. The method of claim 1, further comprising placing a passive RFID tag within a real-world version of the building at a location that corresponds to the third location.

7. The method of claim 6, wherein the passive RFID tag is configured to transmit the identifier upon interrogation.

8. A system comprising:
processing system;
memory operably connected to the processing system; and
instructions stored within the memory, the instructions causing, when executed, the processing system to:
present an image depicting a floor plan of a building;
enable a user to position a first element at a first location on the image and define the first element as a first waypoint or a first destination;
enable the user to position a second element at a second location on the image, establish a link between the first element and the second element, and define the second element as a second waypoint or a second destination;
enable the user to position a third element at a third location on the image, establish a link between the first element and the third element, and define the third element as a radio tag having an identifier;
generate navigation data in which the link between the first element and the second element is defined as a human-navigable path; and
define, within the navigation data, the link between the first element and the third element as a location indicator establishing that receipt of the identifier from a user in a real-world environment indicates that the user is at a real-world location corresponding to the first location.
